(19) United States
(12) Patent Application Publication
(10) Pub. No.: US 2007/0202881 A1
(43) Pub. Date: Aug. 30, 2007

(54) Data processing

(75) Inventor: Eden Dervan, London (GB)

Correspondence Address: WOLF GREENFIELD & SACKS, P.C., 600 ATLANTIC AVENUE, BOSTON, MA, 02210-2206, US

(73) Assignee: SMS Card Limited, London (GB)

(21) Appl. No.: 11/644,263

(22) Filed: Dec. 22, 2006

Related U.S. Application Data
(63) Continuation-in-part of application No. PCT/GB05/04518, filed on Nov. 25, 2005.

(30) Foreign Application Priority Data
Nov. 25, 2004 (GB) 0425925.5

(51) Int. Cl. H04Q 7/20

(52) U.S. Cl. 455/450

(57) ABSTRACT

In a system and method for automatically handling an incoming inquiry related to an object item. Object data relating to the object item is stored in a database, and an inquiry telephone number to which the inquiry is made is linked to the object item in the database. The inquiry telephone number is identified, allowing the object item to which the inquiry relates to be identified. A data connection with a data receiver is opened, and object data relating to the object item is provided for viewing on a display associated with the data receiver. The inquiry is then connected to an inquiry receiver associated with the data receiver.

This invention relates to the provision and use of a system for providing contact information in response to a request. The invention relates particularly but not exclusively to a method for sending contact information as a message to a message enabled device in response to a voice call to a subscriber number.

The need for efficient provision of information to people making telephone inquiries relating for example to products, services, or individuals is well known. There is also a need to keep track of such inquiries, for commercial analysis, and to ensure that inquiries that cannot be dealt immediately can be followed up later.

One area in which the provision of information is particularly important is the provision of information relating to the sale of real estate to potential buyers, for example, the efficient provision of property details to interested parties. Generally, however, people interested in particular properties have to talk to an advisor to establish which property they are interested in, before they can receive the correct information and before their call can be forwarded to an estate agent/realtor responsible for the property. This is a time consuming process which can result in wrong information being sent out, the inquiry being forwarded to the wrong agent/realtor, and even the loss of potential sales.

Furthermore, most estate agents/realtors spend over 80% of their time in the field which means that they conduct most of their business dealings using a cell phone or the like. This means that when dealing with inquiries forwarded by a central office, the agent/realtor does not have access to beneficial information such as property details, and/or any information on the caller such as their contact details and pre-registered property preferences.

Another area where the provision of information is important is in the provision of personal contact information between individuals. The exchanging of business cards is a well established way quickly and easily to distribute contact information. The storage of a business card provides a historical reference point for many individuals, and thus the success of the business card. However, the business card can be lost or go out of date and needs to be carried with an individual (possibly along with many others) to be readily accessible. Business cards therefore create a natural conundrum, keeping the business card about your person increases the risk of losing the card, but storing the card, for example in a card index, prevents ready access to the information it contains.

With the increasing use of mobile telephones having advanced memory capabilities and personal digital assistants (PDAs), it is desirable to have contact information stored electronically on such mobile devices. To load contact information from a business card onto such a mobile device is however time consuming. It is known to be able to send contact information directly from one mobile device to another, but the amount of information and the format of the information is limited, and such direct electronic transfer is significantly more time consuming and complex than the simple exchange of business cards.

In one aspect, the present invention aims to overcome or ameliorate problems associated with existing methods for handling inquiries and in particular but not limited to handling telephone inquiries relating to products or services such as properties or property services.

According to one aspect of the present invention, therefore, there is provided a method for handling an incoming inquiry related to an object item wherein: object data relating to said object item is stored in a database, and an inquiry telephone number to which the inquiry is made is linked to said object item in said database; and wherein the method comprises: identifying said inquiry telephone number; deriving from said inquiry telephone number the object item to which the inquiry relates; opening a data connection with a data receiver; providing at least part of said object data relating to said object item for viewing on a display associated with said data receiver; connecting said inquiry to an inquiry receiver associated with said data receiver.

According to a further aspect of the invention there is provided a system for handling an incoming voice call related to an object item, for forwarding said voice call, and for providing information related to said object item, said system comprising: a database, wherein object data relating to said object item is stored in said database, and an inquiry telephone number to which the inquiry is made is linked to said object item in said database; call interface means for identifying said inquiry telephone number and for deriving from said inquiry telephone number the object item to which the inquiry relates; data connection means for opening a data connection with a data receiver; data transfer means for providing at least part of said object data relating to said object item for viewing on a display associated with said data receiver; voice call connection means for connecting said inquiry to an inquiry receiver associated with said data receiver.

Another aspect of the invention provides a method for managing the contents of a database for inquiries relating to an object item: providing a plurality of inquiry telephone numbers; allowing object item data for said object item to be stored in said database; allowing at least one of said inquiry telephone numbers to be assigned to said object item; linking each assigned inquiry telephone number to said object item in said database.

Another aspect of the invention aims to address at least some of the issues associated with dealing with inquiries forwarded or transferred to a person responsible for those inquiries.

Accordingly, a further aspect of the invention provides a method for handling an incoming inquiry related to an object item the method comprising: allowing a data connection with a data provider to be established with data receiver; displaying data relating to said object item on a display associated with said data receiver; allowing connection of said inquiry to an inquiry receiver associated with said data receiver whilst maintaining said display.

A preferred embodiment of the invention relates to property and property sales, and usefully the object item is a property and the object item data comprises property details.

Property details can therefore be obtained by prospective buyers quickly and easily as text, pictures and/or video just by calling the number on the FSB (For Sale Board) for example. Other properties in the vicinity can be sent to the prospective buyer if they are interested.

In a further aspect the invention there is provided a method of creating a property management database for automatically processing user inquiries comprising the steps of:

allowing a vendor to input property details to said database;

assigning to each property one or more property telephone numbers, to which property inquiries can be addressed;

deriving for each user inquiry a user number; and

storing for each inquiry said user number and said property telephone number

This usefully allows reports of inquiries to be drawn up providing a valuable marketing analysis tool.

If a call handling agent is assigned to each property and inquiries are automatically forwarded to the appropriate call handling agent, then the outcome of the call (connected/hung up/not answered etc.) can also usefully be logged and reported.

Embodiments according to this aspect of the invention can easily be integrated with current Estate agents systems.

A yet further aspect of the invention provides a method of creating an object item management database for automatically processing user inquiries comprising the steps of allowing a vendor to input object item details to said database; defining a plurality of channels; allocating to each object item a plurality of object telephone numbers, to which inquiries can be addressed, each object telephone number corresponding to a single object item and a single channel; deriving for each user inquiry a user number; and storing for each inquiry said user number, the object item and the channel corresponding to said object telephone number.

This aspect of the invention advantageously allows two categories of information to be stored for each inquiry. The first piece of information relates to the object being inquired after, and the second piece of information can be an operator defined field. A particularly useful field for said second piece of information is the source or media from which the inquiry was obtained.

A yet further aspect of the invention provides a method of labelling object items with telephone numbers to which telephone numbers object inquiries can be addressed, the method comprising the steps of providing a series of unallocated telephone numbers; printing a plurality of labels with said unallocated telephone numbers; displaying on a first object item a first one of said labels; and

subsequently allocating the number on said first label to said first object item, such that each object item is assigned a different one of said series of telephone numbers.

A still further aspect of the invention provides a method of assigning to property locations telephone numbers for display at said property locations to which telephone numbers property inquiries can be addressed, the method comprising the steps of:

providing a series of unallocated telephone numbers for displaying at property locations;

displaying at a first property location one of said unassigned telephone numbers; and

subsequently allocating said displayed telephone number to said first property location such that each location is assigned a different one of said series of telephone numbers

This provides an easy mechanism for managing the FSB's.

In another aspect, the present invention aims to overcome or ameliorate problems associated with existing methods of distributing contact information.

Accordingly a further aspect of the invention provides a method for providing contact information in response to a request, the method comprising the steps of storing in a contact information database contact information for a first user, and a first user telephone number; receiving from a second user, a request addressed to the first user telephone number; deriving from said request, a destination number for said second user; retrieving from the contact information database contact information assigned to said first user telephone number; and automatically making available said retrieved contact information to said second user using the derived destination number.

Contact information can include a wide range of fields including name, company, address, email address, telephone numbers, web address etc. The first user telephone number may be a standard digital exchange number/ISDN number. In certain embodiments of the invention however, any identifier which allows a second user to connect to a communication service (typically at least including voice), could be used. This may include an identifier for a voice over IP service.

Further aspects of the invention are more generally applicable to other types of information, as will be described below.

In one embodiment the request is a voice call to said first user number. In another embodiment the contact information can be made available without further input from the second user although prompts may be used to enable selection of options for delivery. A request may also be made by SMS message, or by email.

In this way, a wide range of contact information can easily be made available to a person requesting it by making a single request or call to the appropriate number. The user number would typically be included on an individual's business card. In this way the number can be distributed with the speed and ease of simply passing over a business card, and the recipient can then request contact information at a convenient time simply by making a single call. In certain embodiments, once connected, the caller can simply hang up for the requested contact information to be made available to him or her.

In one embodiment the retrieved contact information is sent to said second user destination number, and this can advantageously be in electronic format, which in one embodiment permits direct electronic input into a memory device

So for example, to use the system an individual could be passed a business card with a user telephone number on it. At any convenient later time, the recipient of the card would call (or if supported send an SMS text message) from, say, a mobile telephone (or other message enabled device) the number. The relevant information (typically the information on an individual's business card) would then be sent as a message back to the calling (or if supported the SMS texting) number, in one embodiment in a format enabling direct storage.

Including such a number on a business card allows a recipient of the card (although the number could equally be distributed by means other than a business card) to capture relevant contact details quickly on to a mobile phone or other contact information device.

In one embodiment the retrieved contact information is sent to said user as an SMS message, however contact information may also be sent as an electronic business card, a Vcard, flash message, MMI/MMS message, or other suitable formats. Advantageously contact information can include image data, which can be sent as a picture or video message. Using picture messaging it is possible to send an image of a business card, a photo of the individual, or a company logo for example. It can be arranged for such an image to be displayed when that person is calling/or are called. This will greatly assist in recognising or remembering the first user.

It is desirable for a second user to be able to select the format in which information is made available or sent. If the request is made by SMS message, a key word or phrase may be included in the request, specifying a desired format, for example “text” for SMS message, or “bus” for business card etc.

It is important that the information can be stored and used quickly and easily by the person requesting the information. It is therefore desirable that the format be compatible with the application intended by the second user. As user requirements change, new formats in which the information is made available can be provided, without modification of the underlying contact information.

Retrieved contact information can additionally or alternatively be provided by voice announcement. The audio may be recorded by the user and be stored as an audio file in the contact information database, or can be provided using text to speech, from the text information stored. This may offer a simple method for a user to obtain information when it is not required in electronic format, or when the user is unable to receive the information in electronic form, for example over a landline.

The destination number for the second user is, in one embodiment, derived automatically from the received request. A preferred way to do this is to use caller line identification (CLI) on the received request, to establish the number from which the request is being made. This number can be used as the destination number. Alternatively, if the CLI number is recognised as being included in the contact information database, it can be used as a reference to retrieve an alternative number to which information can be sent. In this case information could alternatively or additionally be sent by email to an email address.

It is possible for the number to be retrieved automatically without answering the call; this enables the information to be provided without a call charge for the requesting user or a call receipt charge (in the case of a freephone number).

It will not always be appropriate to determine the second user destination number automatically, and the second user can be prompted for the destination number. This could for example be a voice prompt. The second user can then enter a number, either using a keypad or by voice, the number being interpreted using speech to text technology.

Advantageously an automatic sequence of actions including default and dependent actions can be taken to determine the second user destination number, and optionally to provide the requested information. In one embodiment the CLI number is used as the destination number if that number is message enabled, and in one embodiment the contact information is sent by SMS message. If the CLI number is not message enabled, a prompt for a message enabled number is provided, and/or the contact information is optionally announced by voice.

In one embodiment the interface with the second user is provided by Interactive Voice Response (IVR) which can provide a number of automatic or user dependent prompts. This adds flexibility to the system and allows contact information to be made available for a wide variety of users having different requirements. A user can be led through a menu system if desired. This could present the user with a number of choices, such as the format in which they wish to receive contact information. It remains desirable though, to keep the request process short and easy to use.

The contact information database includes, in one embodiment, at least one telephone number for said first user such that, at the time of making a request, a second user can be connected to the first user's telephone number. Frequently, more than one telephone number will be stored, and the second user can optionally select a number to be connected to, or may be connected to a default number, and subsequently to a secondary or tertiary number if necessary, for example if the first number is not answered.

Thus the method provides callers with the ability to get the latest contact information or be connected to any of the contact numbers that have been made available. This therefore allows the number to be used as a single point of contact, providing a single number that can put someone through to Office, Home, Mobile or provide Email addresses, Fax numbers, Office addresses or other contact information.

In certain applications it may be desirable to distinguish between categories of numbers to which a user can be connected. For example, to allow a call to a mobile to be connected, a first user may have to pay a premium.

In one embodiment the method further allows the first user to enter or update the contact information held in the database. A number of user selected options can also be chosen, such as a default format in which information is provided, or a preferred number to which a second user may be connected.

Unlike a business card the information held against in the database can be updated. This means that should someone have a business card from several years ago, providing it contains an assigned number corresponding to a database record, all they need to do for example, is to call (or if supported SMS text) the number for the latest contact information, or alternatively request to be connected to any of the latest numbers that have been made available. Equally, if the number is owned by a business, it may be assigned to a particular position or department, and the contact information can be updated as required if the person in a position or department changes.

The method may provide increased functionality if the destination number for the second user is stored in stored in a request database. In this way a first user can be provided with details of requests made to the first user number. The details could include the date and time of requests, the number of requests made and the destination number to which information was sent in response to those requests. A report of requests can optionally be sent to the first user. A report of requests made each day or month for example could be provided automatically at the end of that each day or month as appropriate.

According to a further aspect of the invention there is provided a system for providing contact information in response to a request comprising an input interface adapted to receive a request from a second user addressed to a first user number, a processor adapted to derive from said request a destination number for said second user, a database for storing contact information corresponding to user numbers; and an output interface adapted to automatically send contact information corresponding to said first user number to said second user destination number.

In one embodiment the system further comprises a user interface to allow said first user to input or update contact information corresponding to said first user number.

The user interface is desirably web based, allowing users freely to subscribe to the service and input information, or to update information.

According to a further aspect of the invention there is provided a method of creating a subscriber contact information database for automatically distributing contact information in response to requests, said method comprising allowing a subscriber to input or update contact information in said database; and providing the subscriber with one or more subscription numbers to which requests for contact information can be addressed.

A subscriber can usefully be provided with the capability of entering contact information manually, or by downloading information from another memory location. The method may require certain fields to be entered, and may require certain options to be selected.

A particularly useful option is to allow a subscriber to obtain and/or control a plurality of subscription numbers. This may be particularly useful to businesses, which may wish to obtain a large ‘block’ of numbers. An administrator can then assign individual numbers within the firm. The user interface desirably has different levels of security, such that permissions may be granted among a group of subscribers. According to the security level of the user accessing the database, certain field may be editable while others may be locked. For example, a company name or position field may only be editable by a ‘block’ administrator. The administrator can optionally assign different security levels and permissions.

Blocks of sequential numbers, or numbers which are easily remembered may be desirable and can be issued selectively, for example on payment of a fee, or only if a block of a certain minimum number is requested.

According to a further aspect of the invention there is provided a method for monitoring use of a subscriber contact information system, said system including a subscriber database for storing a subscriber number and associated contact information for subscribers, and said system allowing users to make remote requests for said contact information from said database, the method comprising receiving from a user, a request addressed to a subscriber number; deriving from said request a user destination number; and creating in a usage database a record of said request including said requested subscriber number and the corresponding user destination number.

It can be seen that the method and system of the present invention can usefully extend to building a database of contact information and monitoring and recording transactions relating to that information.

The method can usefully provide to a subscriber a record of requests made to a particular subscriber number and the user destination number corresponding to those requests. Such a record can be sent to the user by email.

Another useful option is to provide to a user a record of requests which have been made from, or which relate to a particular user destination number, and the corresponding subscriber number to which those requests were made. In this way a user can monitor contact information for all or any of the contacts that he or she has requested in the past. In one embodiment the record includes contact information which was returned in response to those requests, or alternatively or additionally contact information currently associated with those subscriber numbers in said subscriber database.

This method can be particularly useful if, an individual loses his or her list of contacts and/or contact information, by losing their mobile phone for example. For a user who had most/all the numbers loaded by using requests, all previously requested information could be downloaded onto a new phone or sent via email. Where subscribers are classified in groups, data concerning the requests made to/from any of the members of that group can be collated. A report can then be provided to one or more members of said group, for example the group administrator.

It will be understood that a wide variety of data abstraction and collation could be performed on recorded data, and a correspondingly wide range of reports can potentially be produced.

According to a fifth aspect of the invention there is provided a method for forwarding a message from a second user to a first user, the method comprising the steps of receiving from a second user, a voice call to a first user number; recording a voice message from said second user; retrieving from a user database an email address assigned to said first user number; and automatically sending said recorded message to said first user via email.

In one embodiment the message is sent to said first user as a digitally coded audio file, but could also be processed using speech to text processing, and sent to said first user as text.

The invention can beneficially be implemented to be self funding. In this way, there is no charge to subscribers for registering with the service and obtaining a number, and revenue is derived by charging users a fee for making a request. A flat fee for making a request and an additional fee for time spent making the request can be charged through a telecoms provider, using for example an 0871 number in the case of the UK.

Premium services, such as the ability to have a request connected to a mobile number, or a memorable number or a group of numbers may be provided to subscribers at a cost.

The invention has thus far been described with respect to personal contact information, however it has been recognised that the underlying inventive concept and the associated benefits can extend to other types of information.

Accordingly a further aspect of the invention provides a method for automatically providing object item data for in response to a user request comprising the steps of:

storing in a database object item data for a first object item and a first object item telephone number;

receiving from a user an inquiry addressed to said first object item telephone number;

deriving from said inquiry a user number for said user;

retrieving from said database said first object item data corresponding to said first object item telephone number; and

automatically sending said first object item data to said user number.

In one embodiment the user inquiry is a voice call to said first object item telephone number, and the object item data is sent to the user as one or more of: SMS message, WAP push, flash message or video stream.

In this way a user can make an inquiry on an item of interest simply by dialing the assigned number. The user need not store the number and can receive data on the selected item almost instantly. The user will typically make an inquiry and receive data on a mobile telephone, PDA or other mobile data enabled device.

In one embodiment said database includes said user number, and a corresponding email address, and in a further embodiment the object item data is additionally or alternatively sent to that email address.

It is desirable that a plurality of telephone numbers are stored for each item, each telephone number corresponding to a single item. In this way, a number of channels can be defined, each telephone number corresponding to a certain channel. This allows the operator of the system to gain from an incoming inquiry both the selected object item and a further piece of information, such as a class of media used to advertise the item.

Advantageously the database additionally includes data for a call handling agent for each item, and the method additionally includes the step of automatically forwarding the user inquiry to the call handling agent.

A further aspect of the invention provides a method for managing object item inquiries comprising the steps of:

storing in a database object item data for a first object item, a first object item telephone number, and a first object item call handling agent data; receiving from a user an inquiry addressed to said first object item telephone number;

retrieving from said database said call handling agent data and said object item details corresponding to said first object item telephone number; automatically forwarding said user inquiry to said first call handling agent using said agent data; and

automatically making available to said call handling agent said first object item details corresponding to said user inquiry.

The making available of said first object item details and forwarding of the user inquiry are desirably performed substantially simultaneously.

It will be appreciated that by providing details relating to the subject of the inquiry, this method allows the call handling agent to manage an inquiry in a more informed and efficient manner.

In one embodiment the method also includes the steps of the steps of deriving from said inquiry a user number for said user and making available to said call handling agent said user number. If the database advantageously includes corresponding user details, these can also be made available to the call handling agent.

It will be appreciated that an object item can be any item of potential interest to a user of the system. The invention is particularly suited to but not limited to the sales industry, allowing a user to retrieve information concerning an advertised product having an associated number. For example a product catalogue may include a brief product description and a telephone number. Details returned might be key dimensions, fitting instructions, technical drawings or even a video sequence demonstrating installation/use.

A call to a number could automatically be put through to an appropriate help desk, and a help desk operator could automatically be provided with details of the product about which the call is being made.

The invention will now be described by way of example with reference to the accompanying figures, in which:

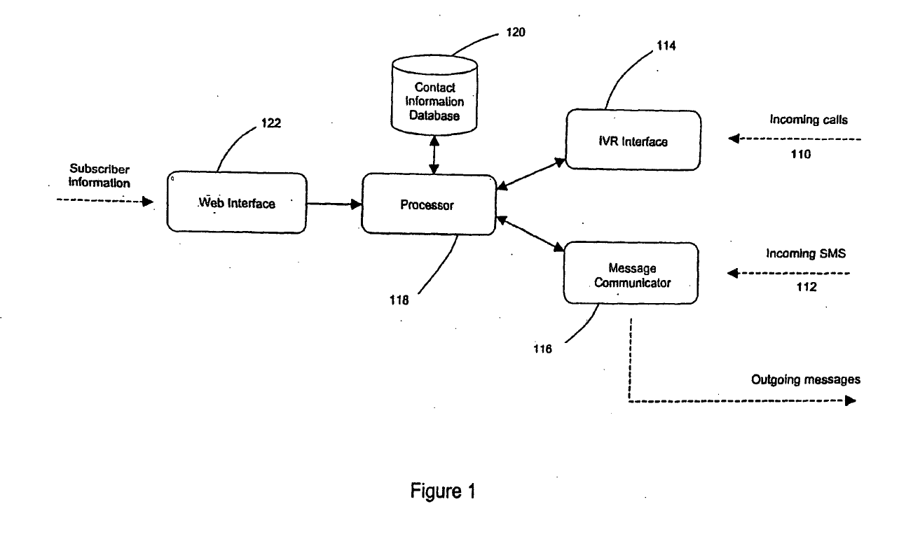

FIG. 1 is a schematic diagram of an SMS Card system according to one embodiment;

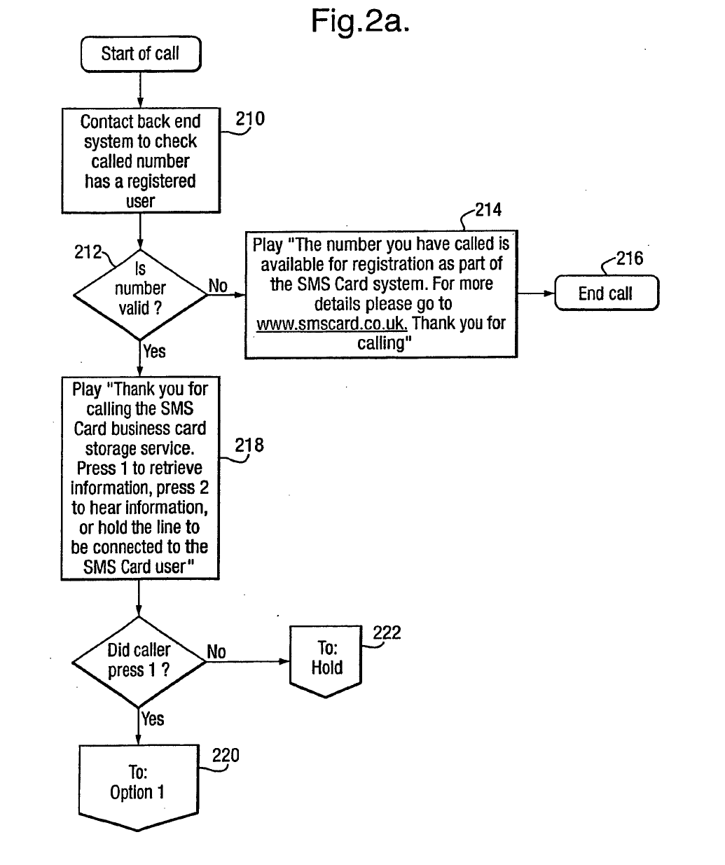

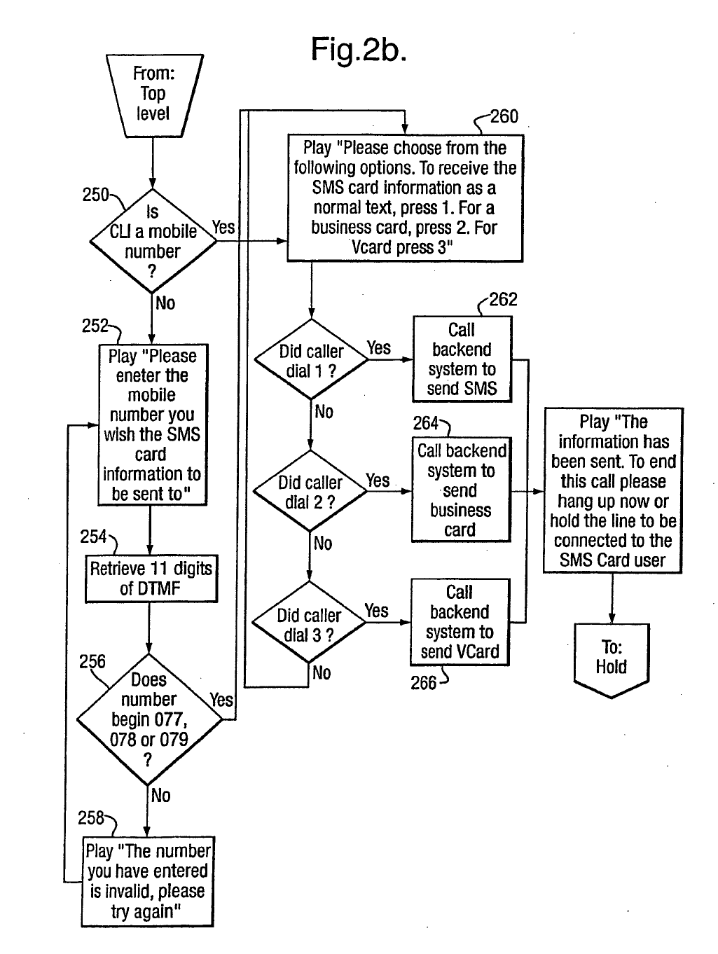

FIG. 2a illustrates the process of calling the SMS Card system according to one embodiment;

FIG. 2b illustrates the process of a further aspect of calling the SMS Card system according to one embodiment;

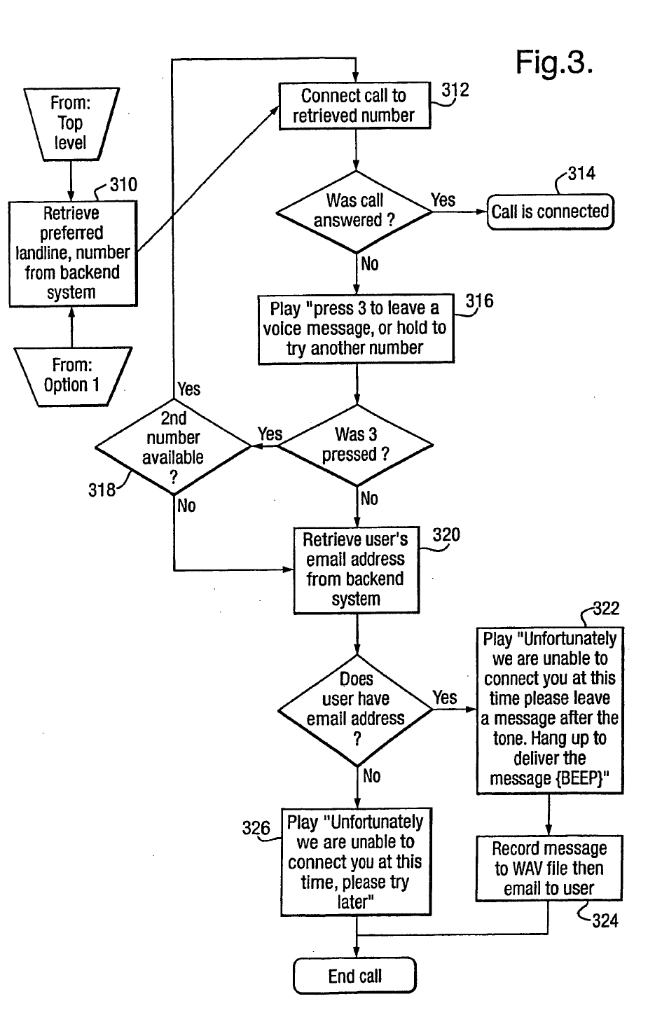

FIG. 3 illustrates the process of connecting a caller to an SMS Card holder according to one embodiment;

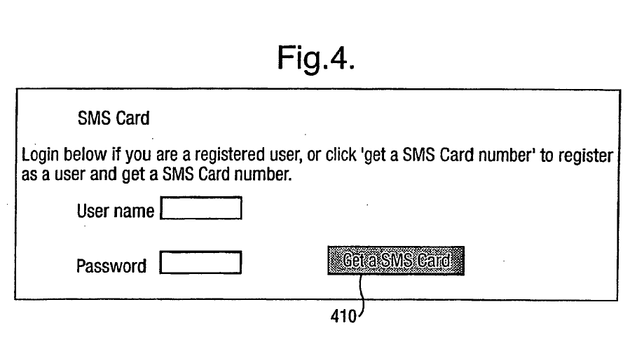

FIG. 4 is a screen shot of a login and registration interface, which may be implemented in conjunction with the system described herein according to one embodiment;

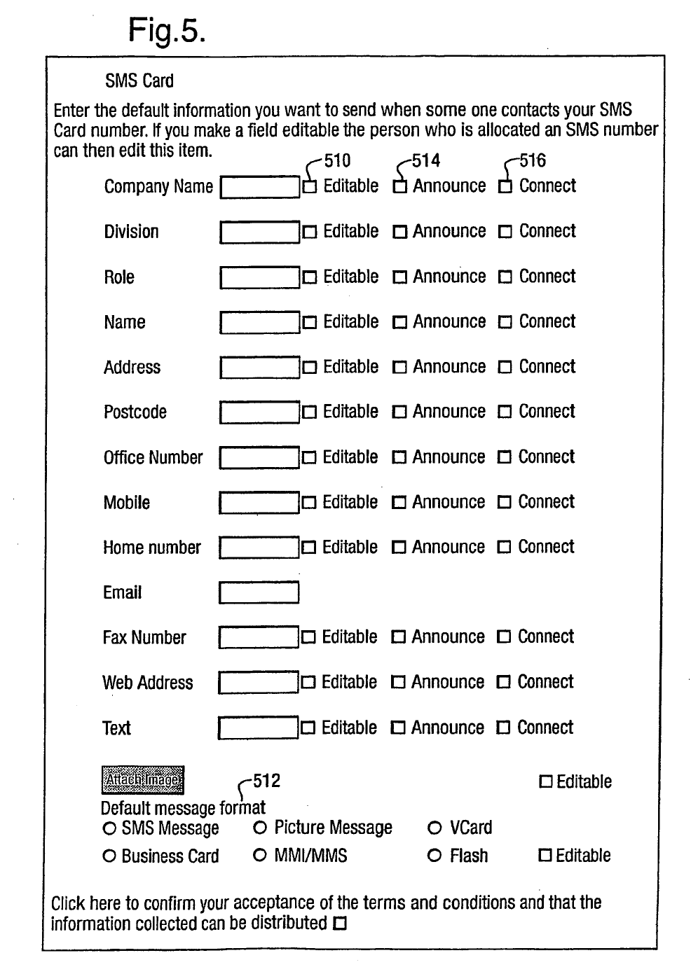

FIG. 5 illustrates one embodiment of a data entry screen, which may enable a user to set up an SMS Card;

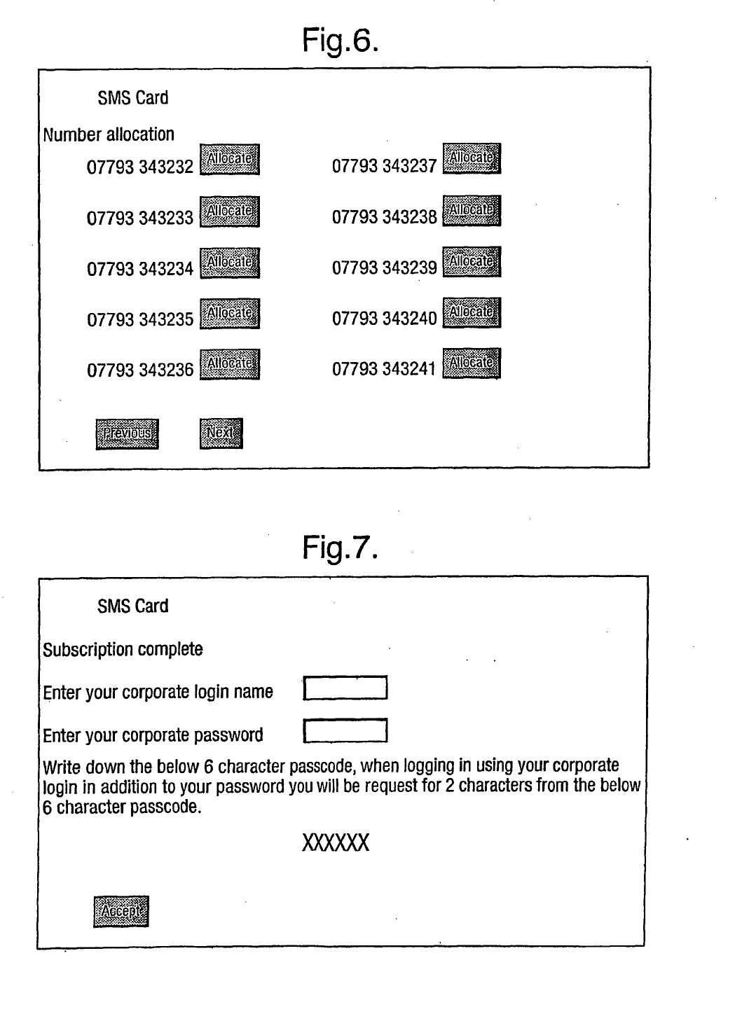

FIG. 6 is a screen shot of a screen that enables a user to allocate SMS Card numbers to individuals;

FIG. 7 illustrates one embodiment of a confirmation screen, which may be presented to a user to confirm that the registration was successful;

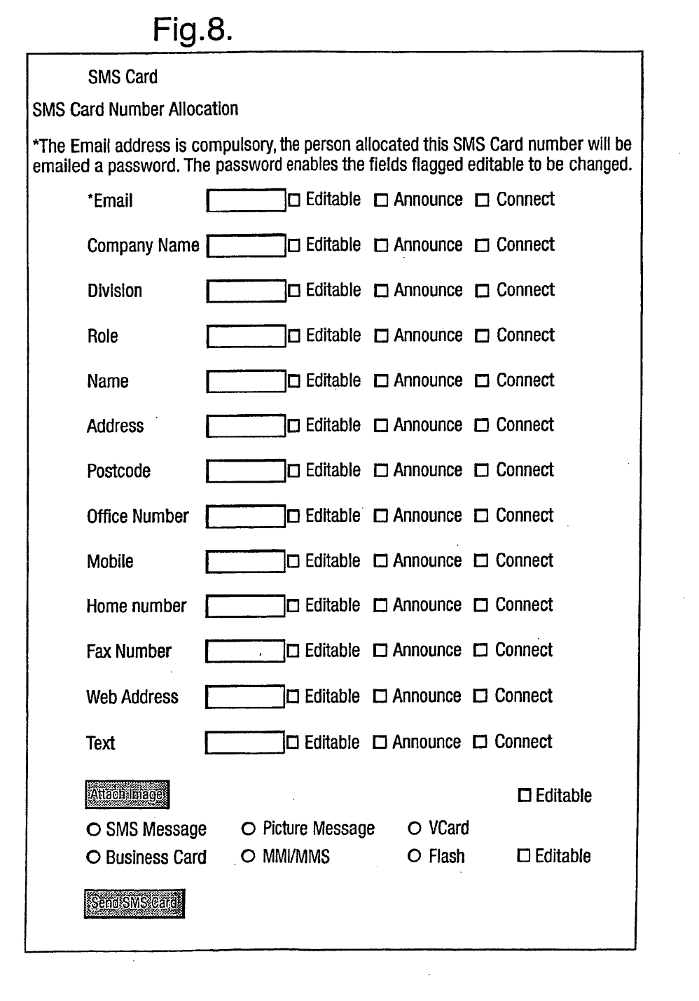

FIG. 8 illustrates a further embodiment of an interface screen that may be used to enable a user to set up an SMS Card number;

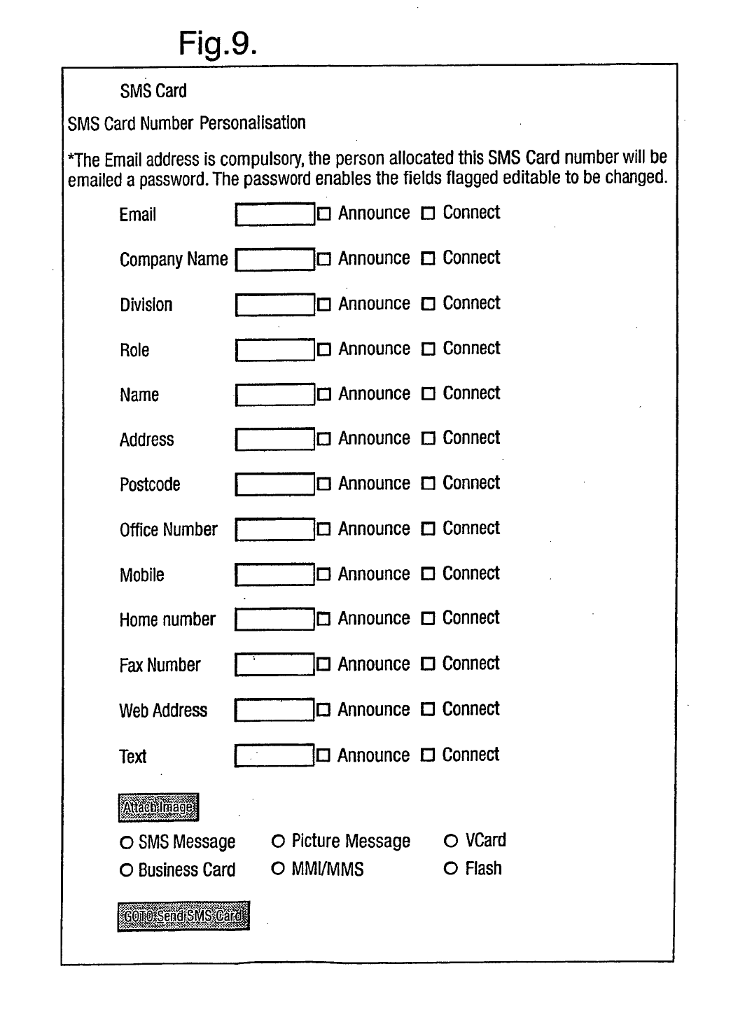

FIG. 9 illustrates an embodiment of a screen that may be used by a user to personalise information that has been entered into the SMS Card system;

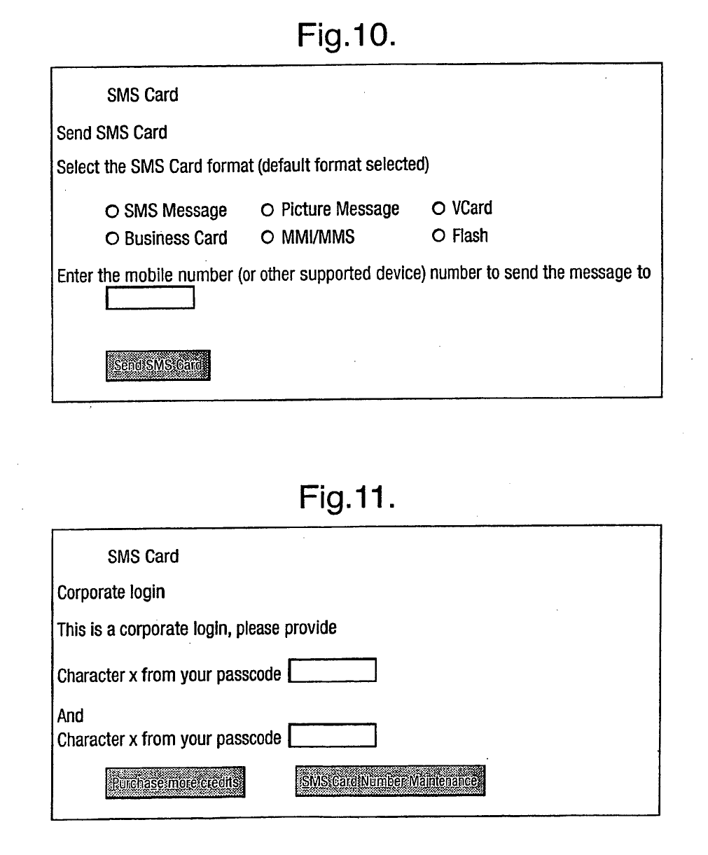

FIG. 10 illustrates an embodiment of a user interface screen that enables a user to transmit an SMS Card to a selected messaging device;

FIG. 11 illustrates one embodiment of a corporate login screen;

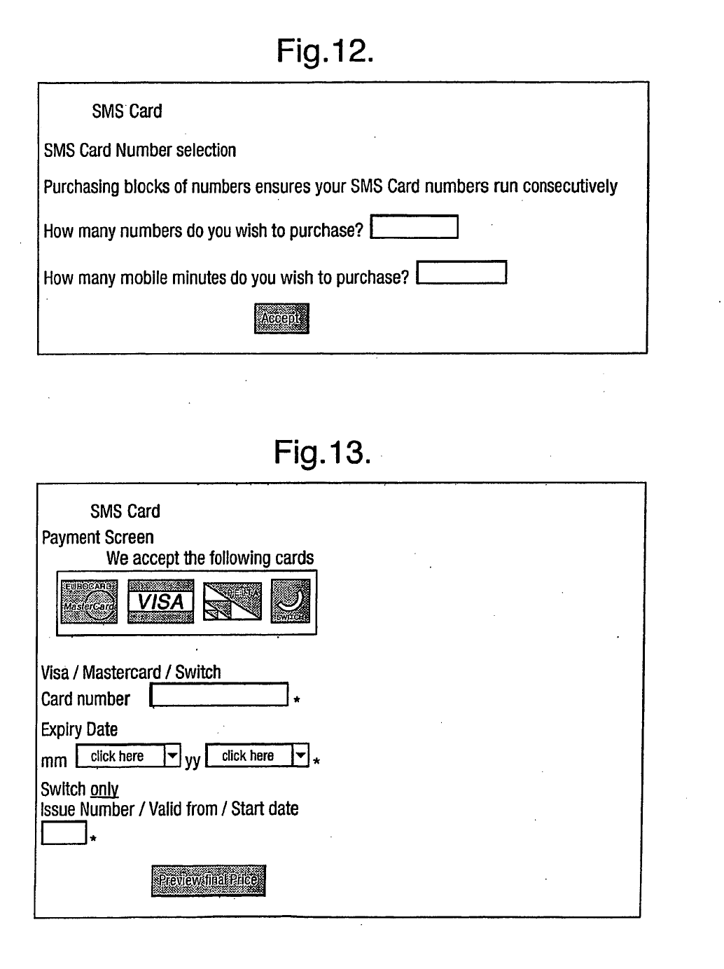

FIG. 12 illustrates one embodiment of a screen that may allow a user, for example a business, to purchase a block of sequential numbers;

FIG. 13 illustrates a payment screen according to one embodiment;

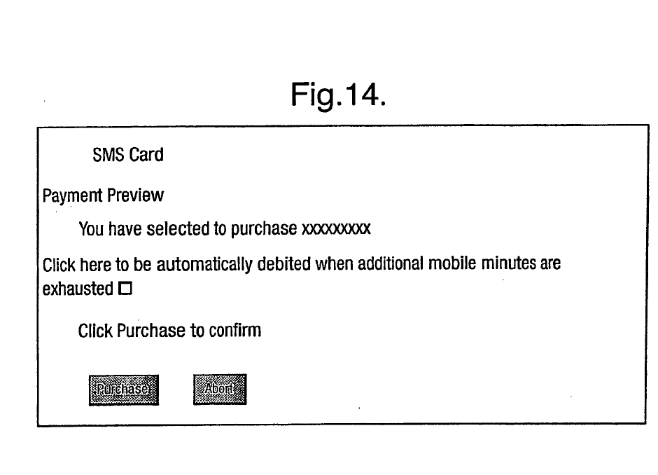

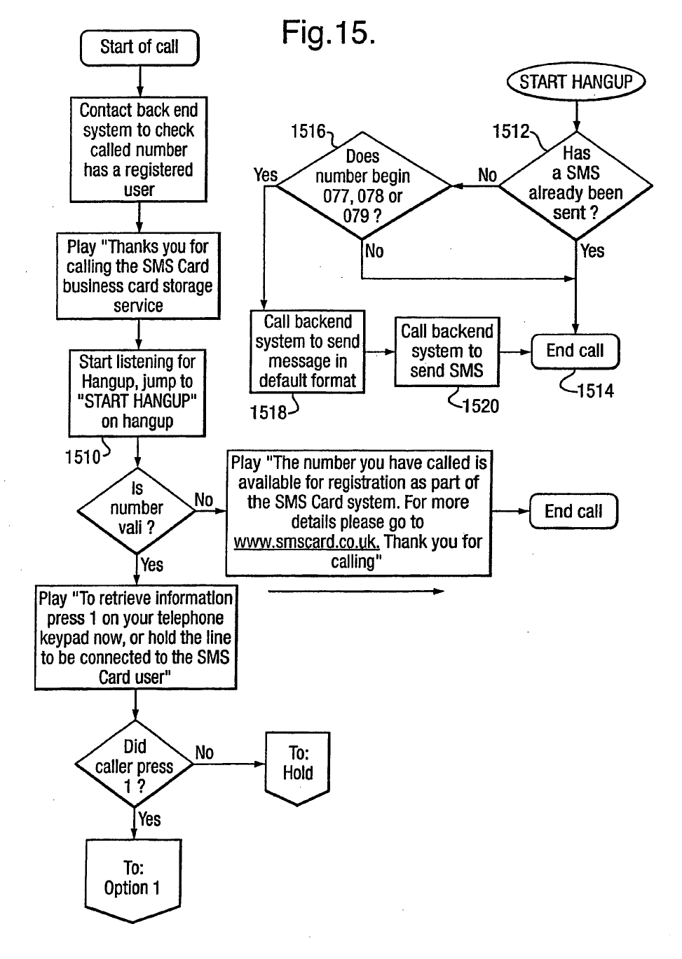

FIG. 14 illustrates an embodiment of a purchase confirmation screen;

FIG. 15 is a schematic diagram illustrating a further embodiment of the process of calling the SMS Card system;

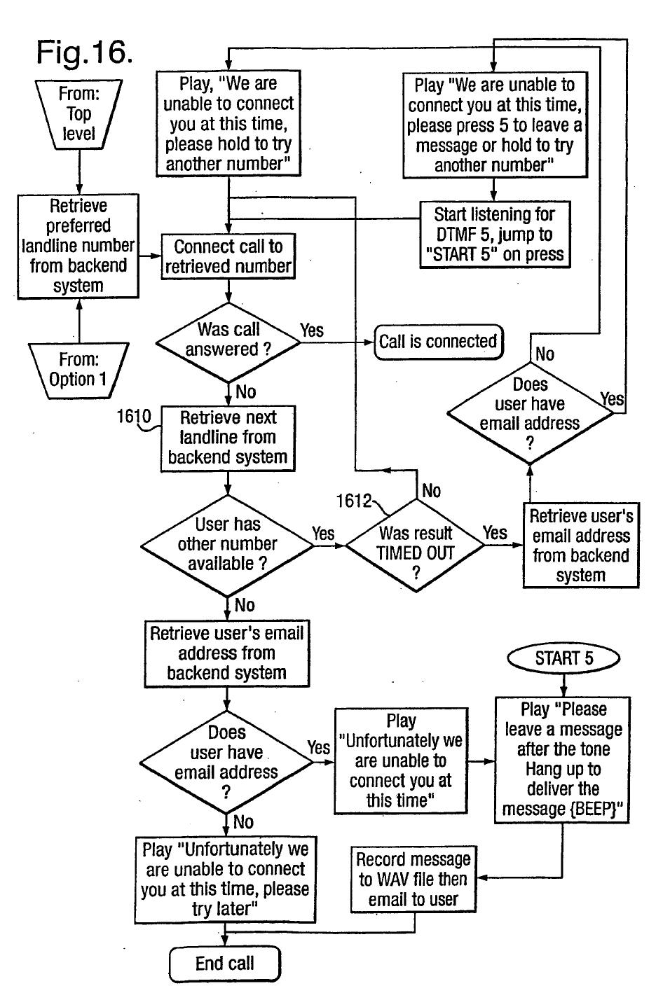

FIG. 16 is a schematic diagram illustrating the process of connecting a caller to a registered user according to one embodiment.

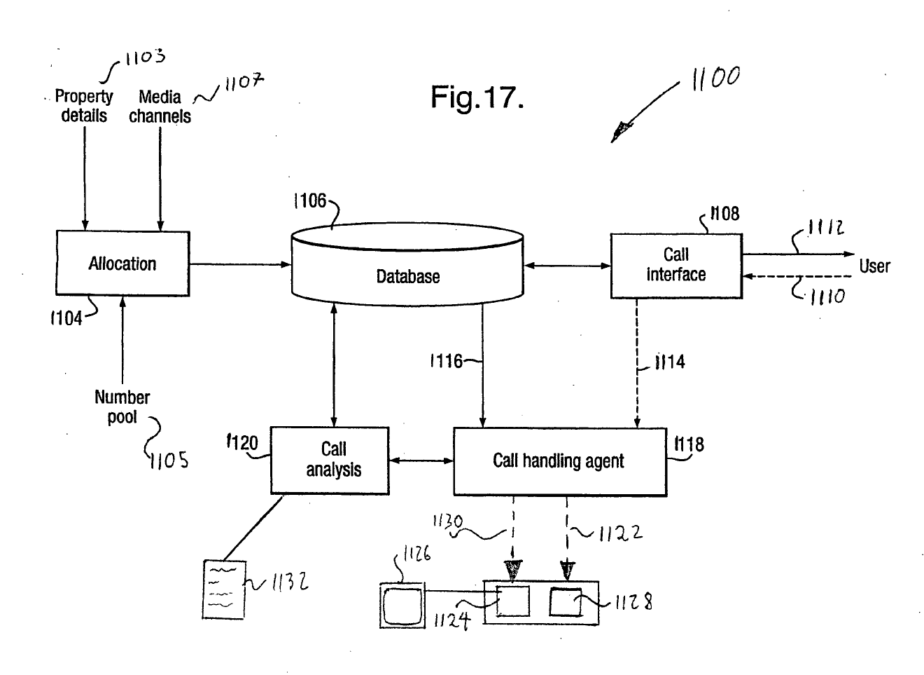

FIG. 17 is an overview of a system incorporating embodiments of the present invention;

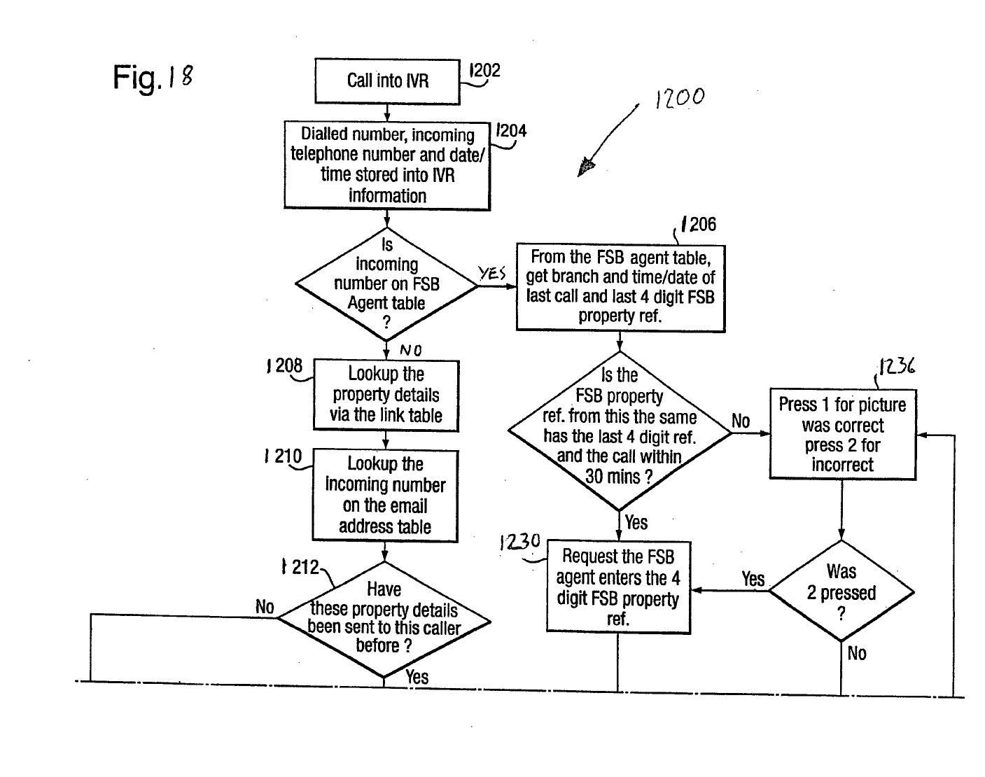

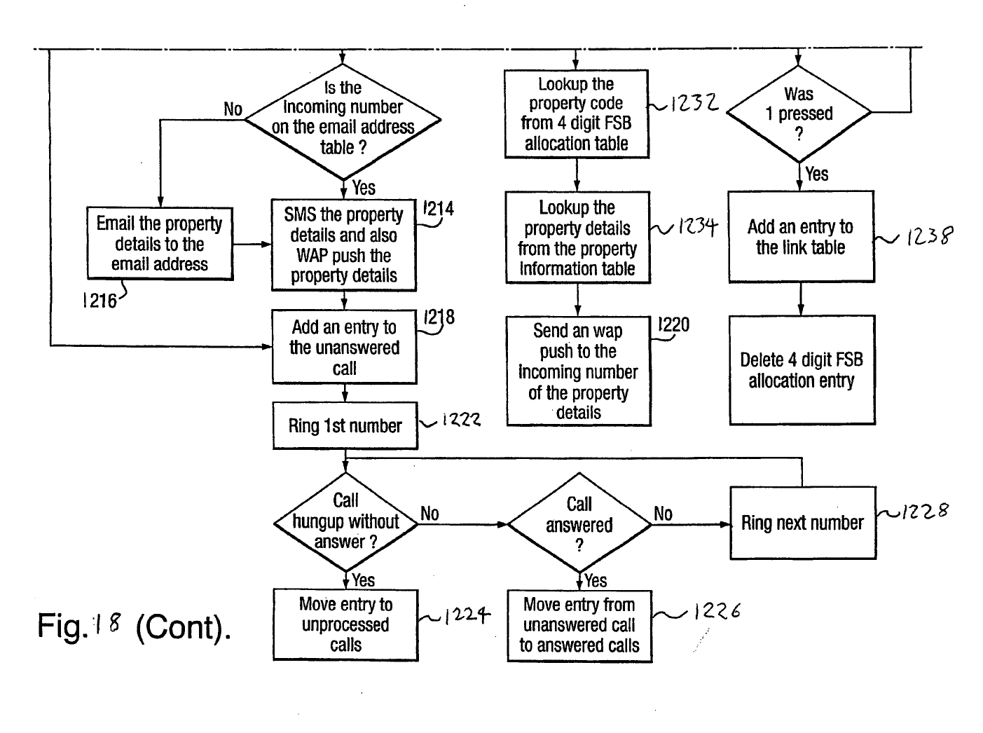

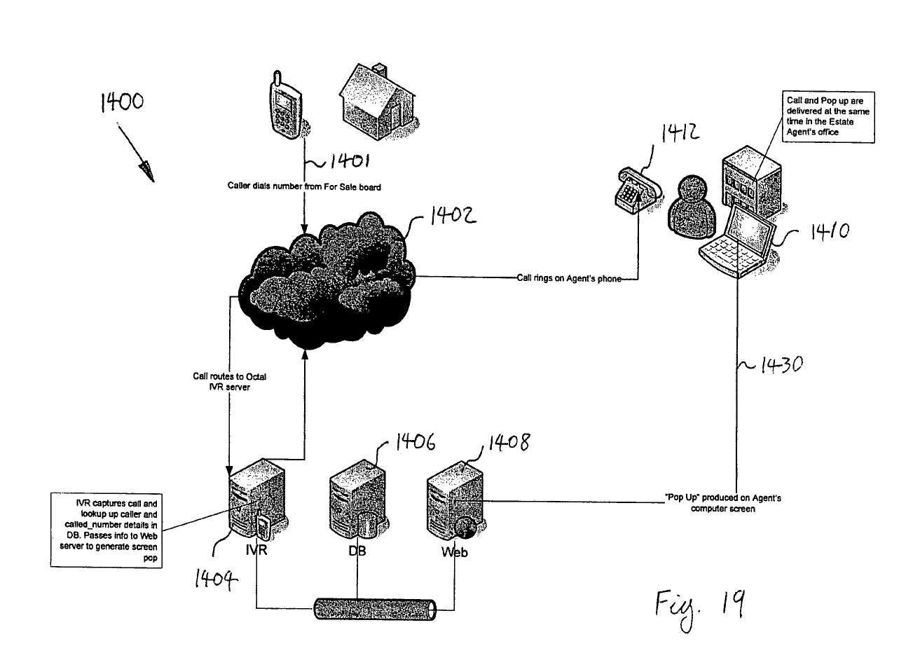

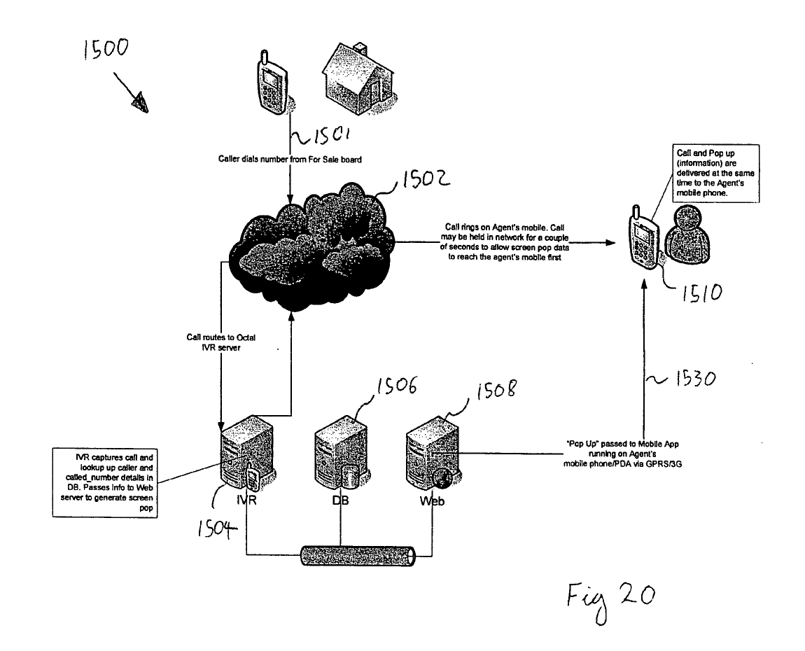

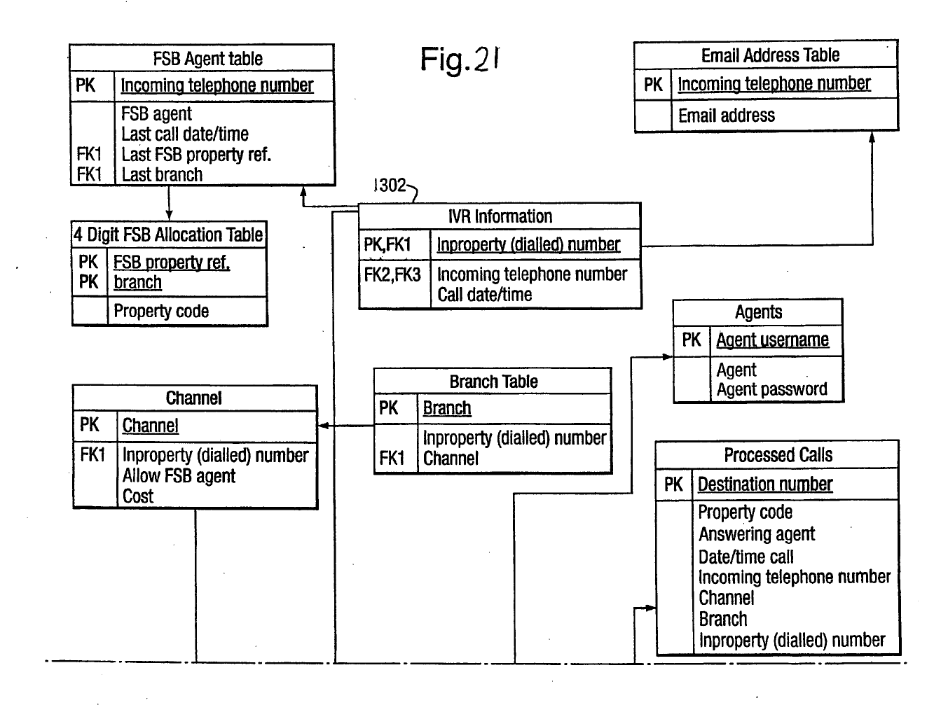

FIG. 18 is a flowchart of a call handling and database management system according to embodiments of the present invention

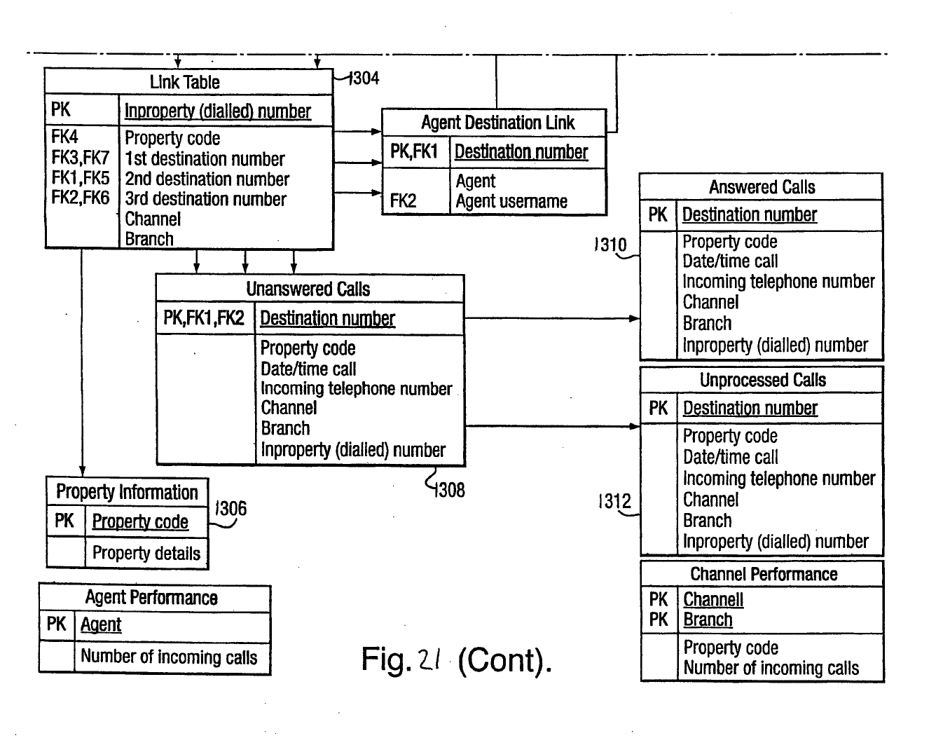

FIG. 19 is an overview of a first system for call handling and forwarding;

FIG. 20 is an overview of a second system for call handling and forwarding;

FIG. 21 illustrates a database structure compatible with the flowchart of FIG. 2

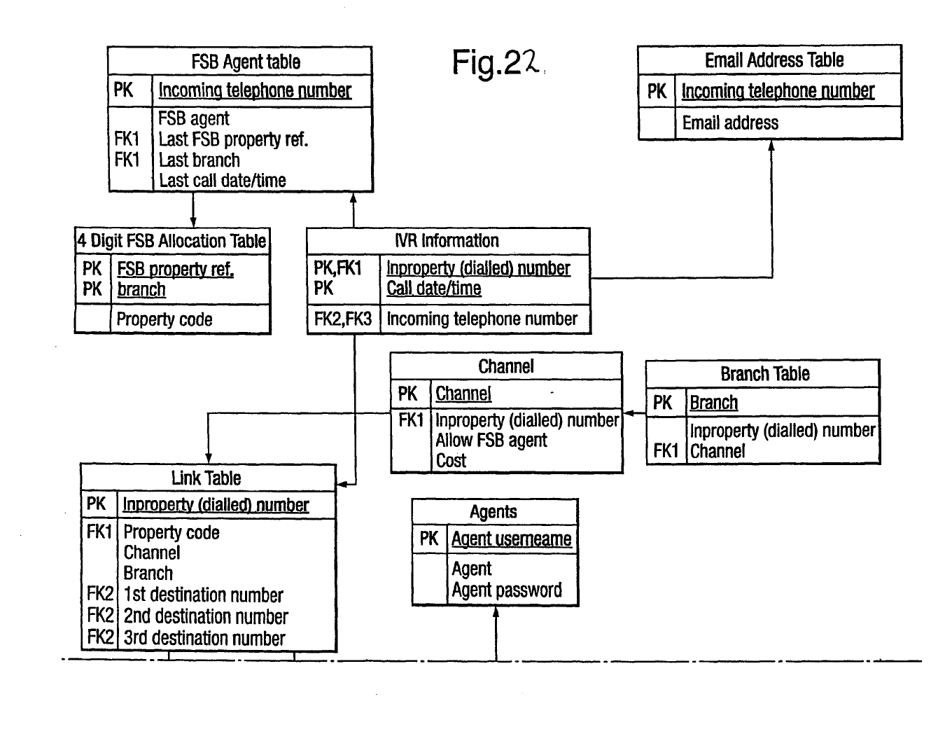

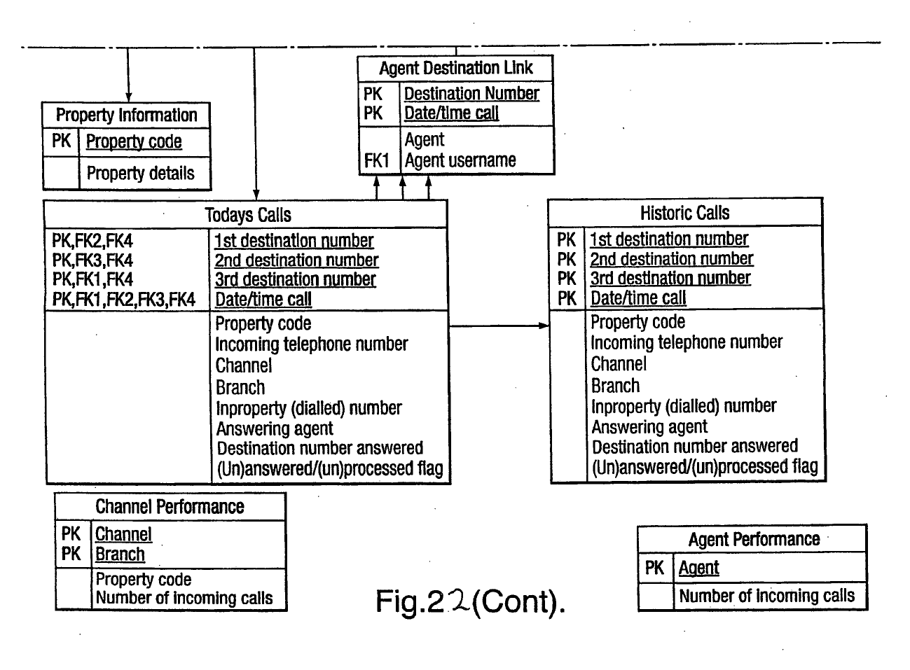

FIG. 22 is an alternative database structure

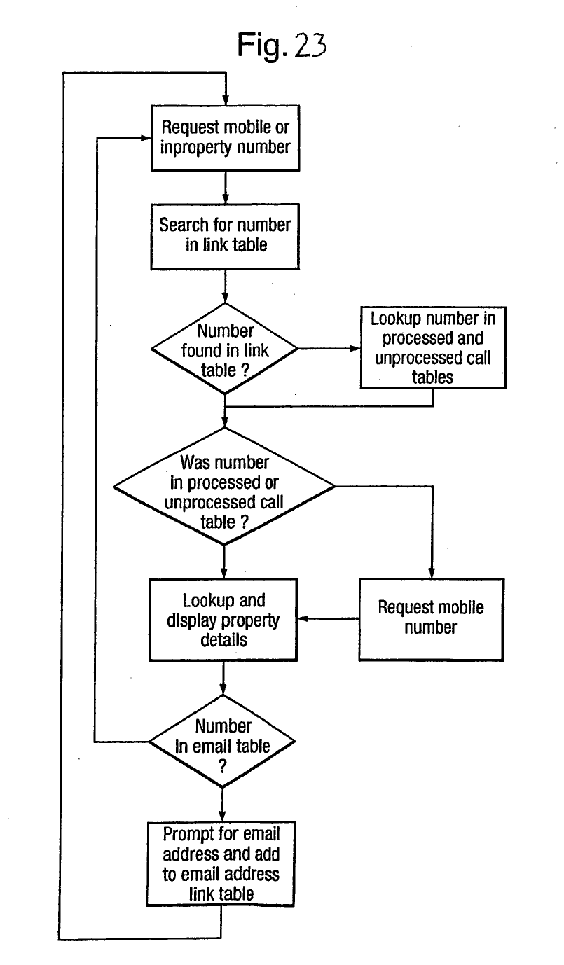

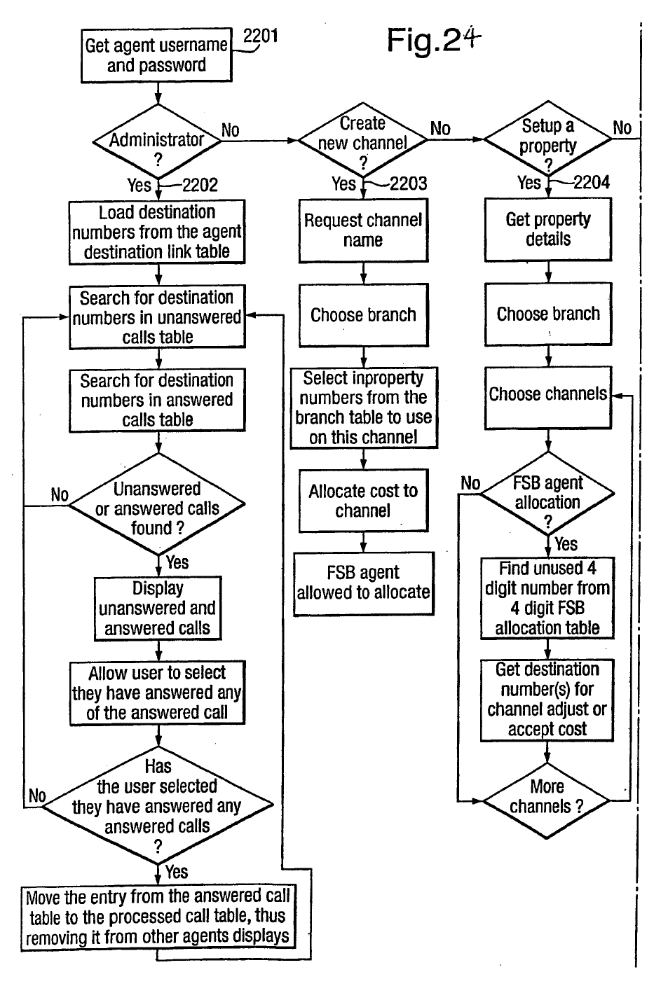

FIG. 23 shows a user interface workflow

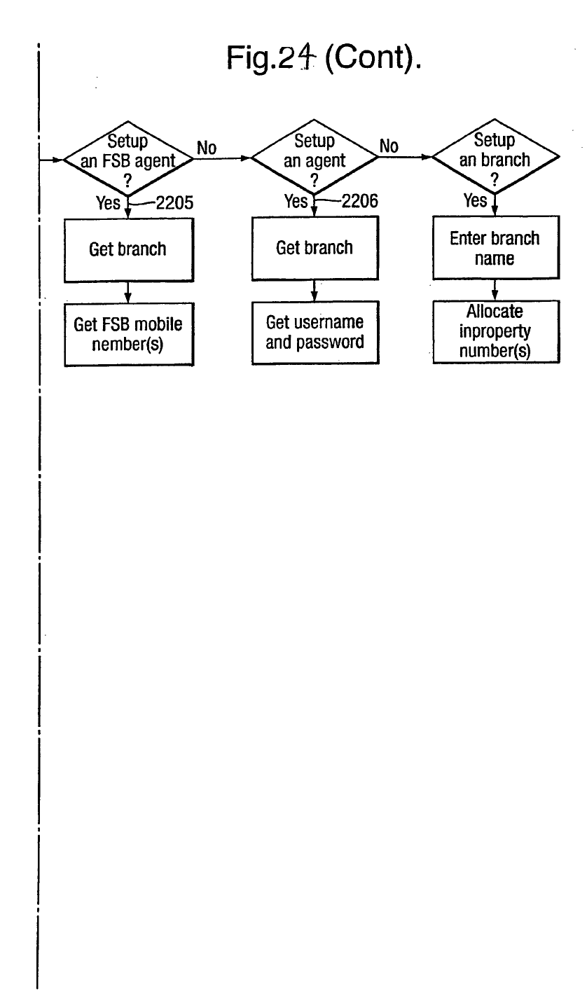

FIG. 24 shows an agent administration workflow

Apparatus that may be used to implement embodiments of the SMS Card system described herein will now be described with reference to FIG. 1.

One or more input interfaces 110, 112 may be provided to receive incoming requests for information. One input interface may 110 receive incoming telephone calls from mobile telephones or from landline or fixed-line telephones. A second input interface 112 may be provided to receive requests for information via SMS messages 112 or other electronic messages.

Requests received over the telephone input interface 110 may be handled by an Interactive Voice Recognition (IVR) and Response Interface 114. The IVR Interface 114 may communicate with the caller to provide requested information and to prompt the caller to obtain information, such as option choices, from the caller.

Requests received by SMS or another messaging system may be routed to a message communicator device 116. The message communicator device 116 may provide an interface between the messaging network and the SMS Card system to receive and/or transmit messages between the system and the requesting user.

A processor 118 may be provided to receive requests input via either interface and to analyse the requests, obtain the required information, for example from a contact information database 120 and output the information in the desired format. The processor 118 may further be connected to a web interface 122 to receive new or updated subscriber information. The processor may analyse and/or format the data received via the web interface 122 and store or update the information in the contact information database 120.

In summary, one or more of the following methods may be provided to enable a user to obtain information using an SMS Card number:
Option 1) Call the SMS Card number, for example from a mobile telephone or a fixed-line telephone.
Option 2) Send an SMS message to the SMS Card number.

Option 1) The user calls an SMS Card number, if they have used a mobile telephone and have not withheld their number they are offered the option of hanging up and receiving the SMS card in the default format or, by responding to a number of prompts, the user may be connected to available numbers, listen to information or select the format in which they would prefer to receive the SMS Card (formats offered may include one or more of: SMS, Flash, Picture Message, Business Card, Vcard, email).

If the user withholds their number or calls from a land line they may be requested to enter the mobile number to which the SMS Card should be sent and may then be offered the option of hanging up and receiving the SMS card in the default format. The user may also respond to a number of prompts and may be connected to available numbers, listen to the information, or respond to prompts to decide the format in which they would prefer the SMS Card (formats offered may include one or more of: SMS, Flash, Picture Message, Business Card, Vcard, email).

Option 2) The user sends an SMS to the SMS Card number. If the message sent to the SMS Card Number contains one or more predetermined keywords, the user may be sent the SMS Card in the format associated with the keyword, otherwise they will be sent the SMS Card in the default format.

One embodiment of the process of calling the SMS Card number (Option 1 described above), for example using a mobile telephone or fixed-line telephone network, is set out below:

a) User calls the SMS card number

b) IVR system answers call

c) If the user hangs up at anytime without selecting valid options and the IVR system was able to obtain the calling number and the calling number was a mobile number (or other message-able device) the IVR system will instruct the back-end system to send a SMS card to the calling number. The SMS card will be sent in the SMS Card number holders default format.

d) If the user stays on line they will be request to press ‘1’ to receive SMS card information or press ‘2’ to hear the SMS Card information, or stay connected to be put through to the [Office/Direct line/Mobile/Home]. However if more than one number has been made available the user may be offered an additional option i.e. press ‘3’ to choose a contact number to call.

Pressing ‘1’

If the IVR system is unable to obtain the calling number or the calling number is not a mobile number (or other message-able device) the IVR system will ask (for example using a recorded voice) for the user to enter the mobile (or other message-able device) number to send the SMS Card to.

The IVR system will then request (via a recorded voice) for the user to select their preferred SMS card format, the user will then select their preferred format using their phone keypad (DTMF). Formats may include SMS, picture message, flash, MMI/MMS, business card, VCard etc. The IVR system will then instruct the back-end system to send a SMS card to the calling number in the selected format.

Pressing ‘2’

If a WAV file has been uploaded then this will be replayed otherwise all the stored SMS Card information will be announced using text2voice software in the order on the form (in one embodiment, a user may be able to select the order in which the information is announced).

Pressing ‘3’ (If More than 1 Number has been Made Available to Call)

The IVR system will request the selection of the contact number to be put through to i.e. press 1′ for Mobile, press ‘2’ for Office number, press ‘3’ call Home. If the number is a mobile or other high rate number the option to be connected may be offered if a fee is paid by the caller or if the SMS Card number owner has paid to cover the associated costs.

One embodiment of the process of sending an SMS to a SMS Card number (Option 2 described above) will now be described in more detail.
a) User sends an SMS message to the SMS Card number.
b) The SMS processing system will pass the message to the back-end system, if the message contains no keywords a SMS Card will be sent in the SMS card number holder's default format to the number that the SMS message came from.
c) If the SMS message contains a keyword the back-end system will send the SMS Card in the format applicable to the keyword to the number that sent the SMS message. Examples of keywords may include ‘SMS’ for SMS Messages, ‘PIC’ or ‘PICTURE’ for Picture messages, ‘FLASH’ for a Flash message, ‘MMI’ or ‘MMS’ for MMS message format, ‘B’ ‘BUS’, ‘BUSINESS’, ‘BCARD’ for business card format, or ‘V’, ‘VCARD’ for VCard format.

The use of the SMS Card service according to one embodiment will now be discussed in more detail with reference to FIGS. 2a, 2b and 3.

As set out above, to retrieve information associated with a registered user, the requesting user may telephone an SMS Card number. As illustrated in FIG. 2a, the system may perform a verification procedure according to the following process:
a) The interface that receives the call may contact the back end system 210 (e.g. the processor and contact information database) to check that the SMS Card number that has been called has an associated registered user.
b) In this way, the system determines whether the number that has been called is valid 212.
c) If the number is not valid, for example if there is no associated user in the database, a recorded message may be played to the requesting user 214, for example “The number you have called is available for registration as part of the SMS Card system. For more details please go to www.smscard.co.uk. Thank you for calling.” The call may then be ended 216.
d) If the number is valid, details of the options available may be communicated to the requesting user 218, for example a recorded message may play “Thank you for calling the SMS Card business card storage service. To retrieve information press 1 on your telephone keypad now or hold the line to be connected to the SMS Card user”. Further options may be provided as set out herein.
e) If the caller presses 1, the information may be transmitted to the requesting user in the default format.
f) If the caller holds the line 222, the system may attempt to connect the user to the registered user using a default contact method.

FIG. 2b illustrates schematically the process of retrieving information or connecting to the registered user according to one embodiment.
a) On receipt of a telephone call from a requesting user, the system determines whether the Caller Line Identifier (CLI) of the requesting user corresponds to a CLI of a mobile telephone 250.
b) If the CLI is not a mobile telephone CLI, the system may play a recorded message to the caller requesting that the caller enters the mobile telephone number to which the CLI should be sent 252.
c) The number entered by the user may be retrieved by the system 254, for example using a Dial Tone Multi-Frequency (DTMF) system.
d) The system may then check the number entered to ensure that the number corresponds to a device that can receive the default type of message 256. For example, in the UK, the system may verify that the number entered is a mobile telephone number by checking that the number starts with 077, 078 or 079.
e) If the number entered can not receive the default type of message, then an error message may be communicated to the user 258 and the system may enable the user to enter an alternative number, for example “The number you have entered is invalid, please try again”.
f) If the number of the calling user is a mobile telephone number, or if a verified mobile telephone number has been entered, the user may be presented with a number of options 260, for example “Please chose from the following options. To receive the SMS card information as a normal text, press 1. For a business card, press 2. For VCard, press 3.”
g) If the caller dials 1, the system may contact to the backend system to instruct the backend system to generate and send an SMS message 262.
h) If the caller dials 2, the system may contact backend system to instruct the backend system to generate and send a business card 264.
i) If the caller dials 3, the system may contact the backend system to instruct the backend system to generate and send a VCard 266.
j) Once the information has been sent, this may be confirmed to the requesting user 268, for example via a voice message such as “The information has been sent. To end this call please hang up now or hold the line to be connected to the SMS Card user”.

FIG. 3 illustrates one embodiment of the process of connecting a user to the registered user:
a) On request from the requesting user, the registered user's preferred landline number is retrieved from the backend system 310, for example from a contact information database.
b) The call is connected to the retrieved number 312.
c) If the call is answered, the requesting and registered users are connected 314.
d) If the call is not answered, a message may be communicated to the requesting user, for example “Press 3 to leave a voice message or hold to try another number” 316. In an alternative embodiment, the system may retrieve the next contact number from the backend system and try to contact the registered user at that contact number.
e) If a further contact number is available 318, the system may attempt to connect the requesting user to the further number.
f) In the present embodiment, if no further contact number is available, the registered user's email address may be retrieved from the backend system 320 and a message may be communicated to the user 322, for example “Unfortunately we are unable to connect you at this time, please leave a message after the tone. Hang up to deliver the message [BEEP]”.
g) The requesting user's message may then be recorded 324, for example as a WAV file, which may then be emailed to a user.
h) If the registered user does not have an email address, an error message may be communicated to the requesting user 326 before the call is ended, for example “Unfortunately we are unable to connect you at this time. Please try later”.

FIG. 15 illustrates a further embodiment of the process of calling an SMS Card system. The process is similar to that illustrated in FIG. 2a, but includes an additional “Start Hangup” process 1510, which may be implemented at any point during the call at which the requesting user hangs up from the call. The system may listen for a hangup event throughout the call and may then start the Start Hangup process by determining whether an SMS has already been sent to the requesting user 1512. If an SMS has been sent, the call and the process may then be ended 1514. If no SMS has been sent, the system may determine whether the calling equipment of the requesting user is message-enabled equipment. For example, in the UK, the system may determine whether the calling equipment is a mobile telephone 1516 by determining whether the CLI starts with 077, 078 or 079. If the calling equipment is message-enabled, the system may then cause the backend system to generate and send a message to the CLI of the requesting user in the default message format 1518, for example an SMS message 1520.

FIG. 16 illustrates a further embodiment of a process of connecting a requesting user to a registered user. This process is similar to that illustrated in FIG. 3, but the next number for the registered user is automatically retrieved from the backend system and the presence or absence of a number may be used to determine whether the requesting user is connected to an alternative number or is directed to leave a message using the registered user's email address. The process also includes the step of determining whether a call to a user has timed out. If the call times out, the requesting user may then be invited to leave a message using the registered user's email address.

The process of creating an SMS Card number will now be described in more detail with reference to FIGS. 4 to 7

To create an SMS Card, the user may access a web interface, for example a user may go to a particular website. The user may be presented with a login and registration interface, such as that illustrated in FIG. 4. If the user has not previously registered, the user may click the “Get an SMS Card” icon 410 to get an SMS Card Number.

The user may then be presented with a data entry screen such as that shown in FIG. 5 and may enter their company or personal information as appropriate. If the SMS Card number is being set up on behalf of a user (for example by a business), the “editable” tag may be selected to indicate that the information should be editable by the user. The data entry screen may also enable a default message format to be selected.

The announce 514 and connect 516 tags may enable a user to define whether the associated information should be released on transmission of the business card and whether the associated numbers should be used to attempt to connect a requesting user to the registered user.

The SMS Card numbers may then be allocated to individuals, for example using a screen as shown in FIG. 6. Individuals may then be able to personalise the SMS Card number or the personalisation can be done at the time the numbers are allocated.

Initially registered users can use a “contact us” feature.

A confirmation screen, such as that shown in FIG. 7, may then be presented to the user to confirm that the registration was successful and to provide the user with a passcode. Sections of the passcode may be requested when the user logs in, in addition to a preselected login name and password, for additional security.

Further interface screens that may be provided in conjunction with the system described are illustrated in FIGS. 8 to 14.

FIG. 8 illustrates a further embodiment of an interface screen that may be used to enable a user to set up an SMS Card number.

FIG. 9 illustrates an embodiment of a screen that may be used by a user to personalise information that has been entered into the SMS Card system, for example to edit any editable fields and to define whether information should be announced or transmitted to a requesting user or whether numbers should be provided to enable a requesting user to connect to the registered user.

The interface screen illustrated in FIG. 10 may enable a user to transmit an SMS Card to a selected messaging device. The SMS Card format may be selected and the number of the messaging device may be entered before the SMS Card is transmitted.

FIG. 11 illustrates one embodiment of a corporate login screen, which may be used to enable corporate users to access, monitor and update their accounts. For example, the user could purchase more credits for any paid aspect of the service or alter information relating to the SMS Cards.

Further interface screens may be provided for billed services or for SMS Card services provided on numbers that are not self funding. For example, FIG. 12 illustrates one embodiment of a screen that may allow a user, for example a business, to purchase a block of sequential numbers.

FIG. 13 illustrates a payment screen according to one embodiment. A secure payment system is desirably provided in conjunction with the present system. A confirmation screen, such as that shown in FIG. 14 may be provided to confirm to a user what will be purchased and the total cost.

In some embodiments, it may be possible to define an image to be associated with the SMS Card, for example a corporate logo. The email may then be transmitted with the business card for some types of cards (e.g. MMS messages or picture messages)

Usage of the system may be monitored and logged, which may enable reports to be produced to detail usage and key performance indicators for the system.

A complete call processing and contact information management system and method has been described, having a number of features. Features of the system may be modified, omitted, augmented or substituted and provided independently or in combination with other features. In particular, each sub menu feature or processing option or branch on the accompanying flowcharts may, as appropriate, be modified or substituted or incorporated as an independent feature in an alternative system. As will be appreciated, prompts may be provided using a variety of media (speech, sound, visual or even other) and specific examples should be taken as implicit references to a generic prompt unless the context explicitly requires otherwise. Similarly, all references to specific communication media or protocols (e.g. telephone, text, multimedia message, picture, voice, email etc.) are intended to encompass any appropriate generic communication medium or protocol, including derivatives of existing standards, unless otherwise explicitly required.

It will be appreciated that in addition to the provision of personal contact information, the allocation of a unique telephone number to a predetermined information record, or set of information records, has many other applications. One particularly beneficial application, for example, is provision of information about particular properties to potential clients of estate agents/realtors.

In FIG. 17, a property information system is shown generally at 1100. The property information system is provided with an allocation engine 1104, a database module 1106, a call interface module 1108, a call handling agent module 1118, and a call analysis module 1106.

The allocation engine 1104 is provided with access to a pool 1105 of telephone numbers, for example national rate telephone numbers, to which a user of the system may make a telephone call to inquire about a specific property.

In operation, when a property is taken on by an estate agent/realtor, the property details 1103 are entered into the system 1100 in association with a unique property code and are allocated at least one unique telephone number from the pool 1105 using the allocation engine 1104. Alternatively, the property may be allocated a plurality of unique telephone numbers from the pool 1105, each allocated number being associated with a different marketing channel 1107. For example, each property may have different telephone numbers allocated to a for sale board (FSB), the local press, the national press, a specific magazine, a targeted mail-shot, a window display, a website and/or any other media channel.

The property details, the associated allocated numbers and corresponding media channels are stored in the database 1106. For each property additional relevant information is also stored in the database, for example a contact telephone number for each agent/realtor responsible and their assistant for handling inquiries about the property.

When the property is advertised through a particular media channel the relevant telephone number is displayed. For example, the number associated with a FSB media channel will be displayed on a for sale board located at the property.

Once an allocated number is no longer required, for example when a property is sold, the number is returned to the pool 1105 for re-allocation as required.

The call interface module 1108 is configured to handle incoming calls to, and outgoing calls/messages from, the system. The module 1108 may comprise any suitable interface but typically incorporates an IVR interface, a processor, and/or a message communicator generally as described with reference to FIG. 1. The call interface module is preferably further configured to allow remote allocation of an inquirer number to a particular property and/or media channel.

In operation, when a user of the system makes an inquiry call 1110 to any of the inquiry numbers in the pool 1105, the call 1110 is processed by the call interface module 1108. The interface module 1108 identifies the inquiry number to which the inquiry call 1110 was made and queries the database 1106 to identify a property to which the inquiry call 1110 relates from the identified inquiry number. If the query is successful details relating to the identified property are retrieved from database.

The interface module 1108 attempts to identify the incoming/originating telephone number of the person making the inquiry. If successful, the module 1108 checks if the inquirer telephone number is indicative of an inquirer to which a message can be sent. This may be achieved, for example, by checking that the originating number is for a phone capable of receiving such messages, or that the telephone number has pre-registered address information, for example an e-mail address, to which a message may be sent.

The interface 1108 is also configured to store relevant details of the inquiry call in the database. The call details stored in the database typically include the time of the call, the duration, the inquirer telephone number where available, and/or whether the call was answered. The details may be stored in association with any pre-registered details of the inquirer and/or the details of previous calls by the inquirer.

If the inquirer phone is message capable and/or pre-registered address information exists, a message containing relevant details of the property is automatically generated and sent to the inquirer as indicated by arrow 1112. The actual details sent and the format of the message are configured according to the nature of the communications network over which the message is sent.

For example, a simple text message containing a summary of the retrieved property details may be generated and sent back to the inquirer at the cell phone number from which the inquiry is made. Alternatively or additionally, a WAP push message containing further details, or details of similar properties in a neighboring area, can also be sent to the inquirer. The message may, for example, include the number of bedrooms, number of reception rooms, number of bathrooms, any particular features of the property such as new kitchen or large garden etc and asking price. Furthermore, an email may be sent to a pre-registered email address, or the sending of a hardcopy of the property details to a pre-registered postal address may be initiated.

The call interface 1108 also automatically routes the incoming call via the call handling agent module 1118 to an agent assigned responsibility for the property to which the inquiry relates (indicated by broken lines 1114 and 1122). based on the agent/realtor details stored in the database. The call can alternatively or additionally be forwarded to an office for queuing, to a specific DDI number, or a managed combination of the two.

Each agent/realtor is provided with data reception means 1124 having an associated display means 1126, and an inquiry reception means 1128 for receiving a voice call. The data reception, display, and inquiry reception means may comprise any suitable devices and may be implemented either as separate devices or as a fully or partially integrated device. For example, the data reception and display means 1124, 1126, may be implemented using a conventional computer, and the inquiry reception means may be implemented as conventional land line or cell phone. In an alternative or additional implementation, the data reception, display, and inquiry reception means may be integrated into a single device such as a cell phone, personal digital assistant or the like. Exemplary embodiments of such systems are described in more detail with reference to FIGS. 19 and 20.

On receipt of the call via the call interface 1108, the agent module 1118 retrieves the associated property details from the database 1106. The agent module 1118 then initiates a data link 1130 with the data receiver 1124 of the responsible agent or their assistant, and provides the property details, or a subset thereof, over the data link 1130, for viewing on the associated display 1126. The display may be implemented in any suitable manner but typically comprises a “pop-up” screen on the display device, for example, a web browser pop-up or the like.

The agent module 1118 also retrieves, and initiates the display of, any known details of the person making the inquiry, for example, the inquirer telephone number, or pre-registered information such as the inquirer's name, their email address, and/or their property preferences.

Alternatively or additionally, the caller details and/or property details retrieved from the database may be sent to the responsible agent/realtor or assistant, for example by email, or may be provided via a dedicated web site with a fast refresh rate.

The call is forwarded by the agent module 1118 to the inquiry reception means 1128 substantially at the same time as, or soon after, the data is provided to the data reception means 1124. Thus, the agent or assistant handling the call can talk to the inquirer whilst reviewing data relating to the caller and the property to which their inquiry relates. Alternatively or additionally the call interface module 1108 may forward the call to the inquiry reception means of the responsible agent or assistant directly, rather than routing via the agent module 1118.

The analysis module 1120 is configured to analyse the calls logged by the system and to automatically generate a report at predefined intervals. The report comprises a summary of details of all inquiries relating to each property, even if the office is closed. This information is provided to the responsible agent/realtor or assistant and hence, inquiries which may have been missed can be followed up at a more convenient time.

The various elements of the system and method outlined above will now be described in more detail, by way of example only.

Inquiry Telephone Number Allocation

The allocation module 1104 is configured to allocate an available inquiry telephone number from the available pool 1105, for each standard media channel, automatically when the property details are entered into the database. However, the allocation module 1104 is provided with a manual override to allow properties to be allocated a manually selected number, for example, to allow a high value property to be advertised using a cherished number rather than a standard automatically allocated number.

Furthermore, to allow greater flexibility, the allocation module 1104 does not automatically allocate an inquiry number to the For Sale Board media channel, at the time the property details are entered. Hence, on arrival at the property, the Sign Contractor may use any available board rather than a specific board dictated by a pre-allocated inquiry number. Thus, the FSB inquiry number may be allocated manually after the board is placed.

A first method for allocating the FSB number is for a simple form to be completed at site and returned to the agency indicating which number has been allocated against which property. This can be verified, for example, using a photograph taken after placement of the board.

In a second preferred method for allocating the FSB inquiry number, the contractor dials the number on the erected For Sale Board. On receipt of the call, the call interface module 1108 identifies both the callers originating number and the inquiry number dialed. The module 1108 then determines whether the originating number is present in a table of pre-registered FSB agent numbers provided in the database. If the originating number is recognised the caller is prompted to input the code of the property at which the sign is located. On entry of the code the allocation module identifies the associated property and the inquiry number may then be allocated automatically. Preferably the identified property details are sent to the FSB contractor for confirmation prior to such allocation. Confirmation may be made by a separate call to the same inquiry number once the verification details are received.

Alternatively or additionally a photograph may be taken for verification by the estate agent/realtor, as described for the first method.

User Interface

When a caller dials an allocated number, the Interactive Voice Response (IVR) system of the call interface module 1108 looks up the database record containing information about the property and populates it with the callers' telephone number (CLI), which is then displayed this in real time to the agent. This can either be a hunt group or directed at a specific agent.

To the caller, this is transparent and the call can quickly be directed to the agent/realtor responsible for property called about. If the user has previously registered their details with the system (via a website for example) with their email address, the property details are emailed to them, optionally formatted with the look and feel of the acting agency/realtor firm.

At the end of a predefined period, eg daily, the agency and/or responsible agent is sent an email with details relevant to them of all of the properties called on including the media, time and date of the call, duration of the call and callers CLI.

Audit Trail

This ensures that even if the office was closed or the call was dropped, no lead is ever lost as the agent simply returns the call at a more convenient time. Additionally, by breaking down each call by media, it allows the Agency to track specific marketing medias more closely ensuring that each can be capitalized on. For instance it mat be that one media attracts a particular profile whilst another attracts a different profile.

If the call is terminated against a specific agent, it allows the management team to accurately assess performance against number of phone calls, optimising training requirements. It also allows the Agent to gauge the success rate of particular properties.

Automatic Data Return

The caller is sent a text message containing all of the headline information about the property such as number of bedrooms, features, location as well as the asking price. In addition a mobile Internet (WAP) session can be started allowing the user to receive images of the property and further details such as room sizes etc.

Web Based Interface

A user can additionally log onto a web page to allow them to take advantage of further system features. An Internet link to the web page may be included in the SMS message sent to the user for example. When the user logs onto the website, they are requested to log in by typing their telephone number (which should be the number from which they have made inquiries to the system). This will then bring up details of the property or properties that they have shown an interest in by sending an inquiry. Further details about a user can then be captured that can then be used to profile and target with similar properties. In particular it is desirable to obtain the user's email address so that details can be sent by email in response to future inquiries. An exemplary user interface workflow is illustrated in FIG. 21

The user web page features a search facility e.g., by postcode/city/county, distance from postcode, agent selection, number of bedrooms/bathrooms, house type, price range etc. A user may also subscribe to be sent details as and when properties become available, this also includes notification by SMS, MMS, Email, Agent Call etc

The user web page may be branded as a page from a particular estate agent, and search features can be limited only to include results listed by that estate agent.

Inquiry Logging

Each call to the system is logged and details of Media, Agent, Number of calls per property and Number of calls per agent are recorded.

By using this information, the Agency can quickly profile and identify where specific properties should be advertised—based on price, size, location and other factors, how properties are performing against initial interest shown and how an agent is performing against number of inbound enquiries.

Call Handling Agent Screens

When a call is made against a property, the IVR system passes the call through to the office or agent handling that property. At the same time it carries out a Database enquiry to bring up details of the property and inputs the callers telephone number. Property address, Property code, incoming call No, and media channel, can all be determined.

The details are provided to the agent via an agent web page which is refreshed sufficiently quickly to allow the agent to understand the profile of the caller before or as the call is answered.

More than one agent number can be assigned to a property allowing the inquiry call to be passed around a number of destination numbers. For example, an inquiry to a particular property could be forwarded sequentially to an agent's direct line, that agent's mobile number, an alternative agent's number and finally the office switch board. At each instance, if the call is not connected it is directed to the next number in the sequence.

Agents can then be allocated against the destination numbers (usually DDI's), and an agent can be assigned to a number of destination numbers. This provides a managed many to many relationship between properties and agents and allows a lot of flexibility in the design.

For instance if an Agent was setup called “office watch” and assigned to all of the destination numbers then that agent would receive information on all calls. If the last destination number for each property was the office main switch board number, and all agents were given the switch board number, when a call goes unanswered and moves through the destination numbers, the callers details would become available to all agents when the last destination number is called.

The agent web page can provide a tool for managing incoming calls. The agent can be notified in real-time of calls forwarded to numbers associated with his ID. If all the calls are forwarded to the main office number all users would see the property details. Once the call is answered by a particular operator the web screen is updated to indicate that the call has been answered.

Channel Allocation

An exemplary channel allocation is:

Number 1—For Sale Board

Number 2—Local paper

Number 3—National press

Number 4—Homes magazine

Number 5—Mailshot

Report Generation

Reports which can be generated by Agent include:

Total number of calls

Number of calls answered

Number of calls missed

List all numbers missed to include property details

Number of calls by Media

Breakdown by number

No of calls by property

Breakdown by media

Incoming call handling

A flow process for receiving an incoming user call is shown in FIG. 18 generally at 1200. An incoming call to an inquiry number from the pool 1105 is received by the IVR portion of the call interface module at 1202. The date, time and incoming/originating number of the inquiry are stored at 1204. The incoming number is compared with the entries in a FSB agent look-up table. If the incoming number is found, in the FSB table, the originator of the call is determined to be an FSB agent and an FSB agent routine is commenced at stage 1206.

If the call is not from an FSB agent, the database is accessed for the property details at 1208, and any registered user information such as email address at 1210. At 1212 a determination is made whether the user has already been sent the current property details. If the details have not previously been sent (this is the first time this particular user has dialed this particular number) then a message, for example an SMS text message, is sent to the user at 1214, and optionally the user is also emailed at 1216. If the details have previously been sent (if the user is calling back to register further interest/make an offer for example) stages 1214 and 1216 are bypassed. The call is then logged as unanswered, by default, at 1218.

The user call is connected to the first agent number associated with the incoming inquiry number at 1222. If the user hangs up before the call is answered, the status of the call is updated from unanswered to unprocessed at 1224. If the call is connected the status is updated to answered at 1226. Finally, if the user remains on the line but the call cannot be connected (for example if the agent destination number is busy) the next number associated with the agent is called at 1228.

The FSB agent routine commences at stage 1206, where the details of the last call from that agent are retrieved. If this agent has not called this number within the last 30 minutes, the agent is prompted, at stage 1230, to enter the property code identifying the property for which this number is to be allocated (the property at which the agent has just erected an FSB). The property is identified from the entered property code at 1232, and the details of the property are retrieved from the database at 1234, and are sent to the FSB agent at 1220 for confirmation purposes. If the agent has called this number within the last 30 minutes, the agent is deemed to be calling back to confirm the property details, and is prompted to indicate whether the details are correct at 1236. If correct, the database is updated with the new number allocation at 1238. If incorrect, the agent is returned to stage 1230 to re-enter the property code.

FIG. 19, shows an overview of an embodiment of a system for handling and forwarding user inquiries about properties generally at 1400. The system 1400 is configured to receive incoming inquiry calls 1401 over communications network 1402, to analyse each call to identify the property to which it relates, and to transfer the call to an appropriate agent/realtor or their assistant. The system is further configured to provide additional information relevant to the property and/or the caller directly to the agent/realtor or the assistant to which the call is forwarded.

The system 1400 comprises an interface module 1404, a database 1406, and call handling agent module 1408, similar to the corresponding modules described with reference to FIG. 17. The interface 1404 identifies the inquiry number to which the inquiry call was made and queries a database 1404 to identify a property to which the inquiry relates as generally described previously.

The interface module 1404 also identifies the telephone number of the person making the inquiry where possible, stores relevant call details in the database in association with any pre-registered details of the inquirer, and sends appropriate property details to the inquirer in an appropriate format as generally described previously.

The responsible agent/realtor or their assistant is provided with data reception means 1410 comprising a computer having an associated display device, and an inquiry reception means 1412 comprising a land line telephone for receiving a voice call.

On receipt of the call via the call interface module 1408, the agent module 1408 retrieves the associated property details from the database 1406. The call handling agent module then initiates a data link 1430 with the data receiver 1410 of the responsible agent/realtor or their assistant, and provides the property details, or a subset thereof, over the data link 1430, for viewing on the associated display. The display is implemented as a web based “pop-up” on the display device which appears as an overlay to any information currently on the screen.

The agent module 1408 also retrieves and initiates the display of any known details of the person making the inquiry, for example, the inquirer telephone number, or pre-registered information such as the inquirer's name, their email address, and/or their property preferences.

The computer 1410 is provided with an applet or the like implemented in any suitable manner. The applet is configured to ensure that the information provided by the call interface 1408 module is received, displayed and maintained on the display device throughout the duration of the voice call. The applet is further configured to attempt to re-establish a connection if data communication is lost.

The call is forwarded by the interface module 1404 to the land line telephone 1412 via the network substantially at the same time as, or soon after, the data is provided and displayed via the computer 1410. Thus, the agent or assistant handling the call can talk to the inquirer whilst reviewing data relating to the caller and the property to which their inquiry relates.

The displayed information includes means for allowing the user to enter a diary system for viewing and making diary entries during the call. On making a diary entry the system is configured to automatically send a confirmation email, text message and/or the like to the caller.

The displayed information is further provided with a data entry screen for entry of notes relevant to the call, for example details of actions agreed with the inquirer. This may be made available during the voice call or may be initiated on termination of the call.

The system 1400 of FIG. 19 is particularly beneficial for calls transferred to agents/deputies based in an office or the like.

FIG. 20, shows an overview of an enhanced embodiment of a system for handling and forwarding user inquiries about properties generally at 1500. The system 1500 is configured to receive incoming inquiry calls over communications network 1502, to analyse each call to identify the property to which it relates and to transfer the call to an appropriate agent/realtor or their assistant. The system is further configured to provide additional information relevant to the property and/or the caller directly to the agent/realtor or the assistant to which the call is forwarded.

The system 1500 comprises an interface module 1504, a database 1506, and call handling agent module 1508, similar to the corresponding modules described with reference to FIGS. 17 and 19. The interface 1504 identifies the inquiry number to which the inquiry call was made and queries a database 1504 to identify a property to which the inquiry relates as generally described previously.

The interface module 1504 also identifies the telephone number of the person making the inquiry where possible, stores relevant call details in the database in association with any pre-registered details of the inquirer, and sends appropriate property details to the inquirer in an appropriate format as generally described previously.

The responsible agent/realtor or their assistant is provided with an integrated device 1510 comprising a cell phone, PDA or the like incorporating data reception means, an associated display device, and inquiry reception means comprising means for receiving a voice call. The integrated device 1510 may be configured to operate using any suitable communications environment, for example 3G or GPRS.

On receipt of the call voice via the call interface 1508, the agent module 1508 retrieves the associated property details from the database 1506. The agent module 1508 then initiates a data link 1530 with the data receiver 1510 of the responsible agent/realtor or their assistant, and provides the property details, or a subset thereof, over the data link 1530, for viewing on the associated display. The display is implemented as a web based “pop-up” on the display device which appears as an overlay to any information currently on the screen.

The agent module 1508 also retrieves and initiates the display of any known details of the person making the inquiry, for example, the inquirer telephone number, or pre-registered information such as the inquirer's name, their email address, and/or their property preferences.

The data reception means of the integrated device 1510 comprises an applet or the like implemented in any suitable manner (for example Symbian or Java). The applet is configured to ensure that the information provided by the call interface 1508 module is received, displayed and maintained on the display device both before the voice call is initiated, and throughout the duration of the voice call. The applet is further configured to attempt to re-establish a connection if data communication is lost.

The data link 1530 to the integrated device 1510 may be made using any suitable means but will typically be implemented as a GPRS or 3 G data transfer.

Some communications systems do not allow voice and data calls to be run simultaneously. For such systems the applet is configured to suspend the data connection after receipt and display of the property/caller information from the call interface module, before the voice call is connected. The call interface device 1504 is configured to ‘hold’ the voice call back in the network 1502 for a short period (less than a few seconds) to allow initiation of the pop-up to complete.

The call is then forwarded by the interface module 1504 to the integrated device 1510 soon after the property and any other data is provided for display via the data reception means. Thus, the agent or assistant handling the call can talk to the inquirer whilst reviewing data relating to the caller and the property to which their inquiry relates.

Alternatively, if the communication system allows concurrent voice and data calls, the applet may be configured to receive and display the property/inquirer details and to maintain the data connection during the voice call so that notes relating to the call may entered and appointments made.

The displayed information includes means for allowing the user to enter a diary system for viewing and making diary entries during the call. On making a diary entry the system is configured to automatically send a confirmation email and/or text message to the caller.

The displayed information is further provided with a data entry screen for entry of notes relevant to the call, for example details of actions agreed with the inquirer.

Where the data link is suspended prior to initiation of the voice call it is re-established on termination of the call. The agent module then provides the data entry screen for display on the display device of the integrated device 1510 for entry of notes relevant to the call, for example details of actions agreed with the inquirer. Similarly any agreed appointments may be entered in the diary.

The system 1500 of FIG. 20 is particularly beneficial for calls transferred to agents/deputies when out of the office.

A database structure compatible with embodiments of the invention is shown in FIG. 21. The IVR information table 1302 is used to store both the inquiry telephone number dialed by the user/inquirer, and the user's originating number. The IVR information table is referenced to Link table 1304 to find the associated property code, which can then be used to retrieve the property details from property information table 306.

The Link table is also used to store up to 3 agent destination numbers to which incoming calls are forwarded. Depending on the outcome of the call forwarding process detailed above, the call details are either appended to the unanswered calls table 1308, the answered calls table 1310, or the unprocessed calls table 1312. Tables 1308, 1310 and 1312 store the raw data from which reports can be run providing call statistics for the agent as described above.

An agent administration interface allows an agent to manage and administer the system, and an exemplary workflow is illustrated in FIG. 23. Having logged into the administration area at 2201, an agent is presented with a number of options. Branch 2202 allows an agent to retrieve unanswered or other logged inquiries. Branch 2203 allows an agent to create a new channel. Branch 2204 allows an agent to enter a new property into the system. Branches 2205 and 2206 allow an FSB agent and a call handling agent to be set up respectively. These functions can be performed by a user on screen, or may be performed as part of an automated routine and may be controlled by an agent's existing computer systems.

The database and associated system can be administered by either the agent, by their web developer or by a central administrator common to all agents or a group of agents. As already noted, the above described system offers the advantages:

An agent can be alerted to a missed call and can call that person back

The system can easily be integrated into an agents website and existing database.

Users can be profiled and details of new properties sent directly to their phones either as an automated and/or manual process

Users can register to the system and can easily review properties to which inquiries have been addressed. The system can also forward these details by email automatically where an email address has been registered.

1. A method for handling an incoming inquiry related to an object item wherein:
object data relating to said object item is stored in a database, and an inquiry telephone number to which the inquiry is made is linked to said object item in said database;
and wherein the method comprises:
identifying said inquiry telephone number;
deriving from said inquiry telephone number the object item to which the inquiry relates;
opening a data connection with a data receiver;
providing at least part of said object data relating to said object item for viewing on a display associated with said data receiver;
connecting said inquiry to an inquiry receiver associated with said data receiver.

2. A method as claimed in claim 1 wherein said display, said data receiver, and said inquiry receiver are integrated into a portable communications device.

3. A method as claimed in claim 1 wherein said inquiry receiver is separate to said display, and said data receiver.

4. A method as claimed in claim 1 wherein said data connection is maintained during said inquiry.

5. A method as claimed in claim 1 wherein said data connection is suspended during said inquiry.

6. A method as claimed in claim 5 wherein said data connection is re-established on said inquiry being terminated.

7. A method as claimed in claim 6 wherein, on termination of said inquiry, data entry means are provided via said data connection for entry of data relating to said inquiry.

8. A method as claimed in claim 1 wherein data entry means are provided via said data connection for entry of data relating to said inquiry.

9. A method as claimed in claim 1 wherein said method further comprises deriving an inquirer number from said inquiry.

10. A method as claimed in claim 9 wherein said method further comprises automatically sending at least part of said object item data to said inquirer number.

11. A method as claimed in claim 9 wherein said method further comprises providing said inquirer number for viewing on said display.

12. A method as claimed in claim 1 wherein a forwarding number is stored in said database in association with said object item; and wherein said method comprises connecting said inquiry to said forwarding number.

13. A method for handling an incoming inquiry related to an object item the method comprising:
allowing a data connection with a data provider to be established with data receiver;
displaying data relating to said object item on a display associated with said data receiver;
allowing connection of said inquiry to an inquiry receiver associated with said data receiver whilst maintaining said display.

14. A method as claimed in claim 13 wherein said method is implemented in an applet on a portable communications device.

15. A method as claimed in claim 13 wherein said display, said data receiver, and said inquiry receiver are integrated into a portable communications device.

16. A method as claimed in claim 13 wherein said inquiry receiver is separate to said display, and said data receiver.

17. A method as claimed in claim 13 wherein said data connection is maintained during said inquiry.

18. A method as claimed in claim 13 wherein said data connection is suspended during said inquiry.

19. A method as claimed in claim 18 wherein said data connection is re-established on said inquiry being terminated.

20. A method as claimed in claim 19 wherein, on termination of said inquiry, data entry means are provided via said data connection for entry of data relating to said inquiry.

21. A method as claimed in claim 20 wherein data entry means are provided via said data connection for entry of data relating to said inquiry.

22. A method as claimed in claim 13 wherein said method further comprises providing an inquirer number for viewing on said display.

23. A method for managing the contents of a database for inquiries relating to an object item:
providing a plurality of inquiry telephone numbers;
allowing object item data for said object item to be stored in said database;
allowing at least one of said inquiry telephone numbers to be assigned to said object item;
linking each assigned inquiry telephone number to said object item in said database.

24. A method as claimed in claim 23 further comprising: allowing at least one forwarding telephone number to be stored in association with said object item data for each said object item.

25. A method as claimed in claim 23 further comprising: allowing each inquiry telephone number to be associated with a different media channel.

26. A system for handling an incoming voice call related to an object item, for forwarding said voice call, and for providing information related to said object item, said system comprising:
a database, wherein object data relating to said object item is stored in said database, and an inquiry telephone number to which the inquiry is made is linked to said object item in said database;
call interface means for identifying said inquiry telephone number and for deriving from said inquiry telephone number the object item to which the inquiry relates;
data connection means for opening a data connection with a data receiver;
data transfer means for providing at least part of said object data relating to said object item for viewing on a display associated with said data receiver;
voice call connection means for connecting said inquiry to an inquiry receiver associated with said data receiver.

27. A method for automatically providing object item data in response to a user request comprising the steps of:
storing in a database object item data for a first object item and a first object item telephone number;
receiving from a user an inquiry addressed to said first object item telephone number;
deriving from said inquiry a user number for said user;
retrieving from said database said first object item data corresponding to said first object item telephone number; and
automatically sending said first object item data to said user number.

28. A method according to claim 27 wherein said user inquiry is a voice call to said first object item telephone number.

29. A method according to claim 27 wherein said first object item data is sent to said user without further action.

30. A method according to claim 27 wherein said first object item data is sent to said user as one or more of: SMS message, WAP push, flash message or video stream

31. A method according to claim 27 wherein said user number is the Caller Line Identification (CLI) number of said user inquiry.

32. A method according to claim 27 wherein said database includes said user number, and a corresponding email address, and wherein said first object item data is sent to that email address.

33. A method according to claim 27 wherein user inquiry data including the user number is stored in said database.

34. A method according to claim 27 wherein said object item is a property and wherein said object item data comprises property details.

35. A method according to claim 34 wherein a plurality of telephone numbers are stored for each property, each telephone number corresponding to a single property.

36. A method according to claim 35 wherein a number of channels are defined, each telephone number corresponding to a single property and a single channel.

37. A method according to claim 36 wherein said telephone numbers are displayed on advertising media, each channel corresponding to a different advertising media.

38. A method according to claim 27 wherein said database additionally includes first object item call handling agent data, and wherein said method additionally includes the step of automatically forwarding said user inquiry to said first call handling agent using said agent data.

39. A method for managing object item inquiries comprising the steps of:
storing in a database object item data for a first object item, a first object item telephone number, and a first object item call handling agent data;
receiving from a user an inquiry addressed to said first object item telephone number;
retrieving from said database said call handling agent data and said object item details corresponding to said first object item telephone number;
automatically forwarding said user inquiry to said first call handling agent using said agent data; and
automatically making available to said call handling agent said first object item details corresponding to said user inquiry.

40. A method according to claim 39 wherein the making available of said first object item details and forwarding of the user inquiry are performed substantially simultaneously.

41. A method according to claim 39 further comprising the steps of deriving from said inquiry a user number for said user and making available to said call handling agent said user number.

42. A method according to claim 39 wherein said database includes said user number, and a corresponding user details, and making available to said call handling agent said user details.

43. A method according to claim 39 wherein said object item is a property for sale and wherein said object item data comprises property details.

44. A method according to claim 39 wherein a plurality of enquiries can be forwarded to said call handling agent simultaneously.

45. A method according to claim 39 wherein said plurality of enquiries can be simultaneously displayed to said call handling agent.

46. A method according to claim 39 wherein a corresponding plurality of object item details and/or user numbers and/or user details are also displayed to said call handling agent.

47. A method according to claim 39 further comprising the steps of deriving from said inquiry a user number for said user, and automatically sending said first object item data to said user number.

48. A method of creating an object item management database for automatically processing user inquiries comprising the steps of:
allowing a vendor to input object item details to said database;
allocating to each object item one or more object telephone numbers, to which inquiries can be addressed;
deriving for each user inquiry a user number; and
storing for each inquiry said user number and said object telephone number.

49. A method according to claim 48 wherein inquiries comprise voice calls addressed to said one or more object telephone numbers.

50. A method according to claim 48 wherein said user number is the Caller Line Identification (CLI) number of said user inquiry.

51. A method according to claim 48 further comprising assigning to each object item call handling agent data and in response to an inquiry addressed to an object telephone number, retrieving the call handling agent data assigned to said object telephone number and automatically forwarding said user inquiry to said call handling agent using said agent data.

52. A method according to claim 48 further comprising providing to said call handling agent a report of inquiries addressed to one or more of said object telephone numbers.

53. A method according to claim 52 wherein said report includes all inquiries made in a specified time period.

54. A method according to claim 48 wherein a plurality of telephone numbers are stored for each object item, each telephone number corresponding to a single object item.

55. A method according to claim 54 wherein a number of channels are defined, each object telephone number corresponding to a single object item and a single channel.

56. A method according to claim 55 as dependent on claim 26 wherein said, report classifies inquiries by channel.

57. A method according to claim 48 further comprising monitoring and storing whether an enquiry is connected to said call handling agent.

58. A method of creating an object item management database for automatically processing user inquiries comprising the steps of:
allowing a vendor to input object item details to said database;
defining a plurality of channels allocating to each object item a plurality of object telephone numbers, to which inquiries can be addressed, each object telephone number corresponding to a single object item and a single channel
deriving for each user inquiry a user number; and
storing for each inquiry said user number, the object item and the channel corresponding to said object telephone number.

59. A method according to claim 58 wherein said object items comprise properties.

60. A method of assigning to property locations telephone numbers for display at said property locations to which telephone numbers property inquiries can be addressed, the method comprising the steps of:
providing a series of unallocated telephone numbers for displaying at property locations;
displaying at a first property location one of said unallocated telephone numbers; and
subsequently allocating said displayed telephone number to said first property location such that each location is assigned a different one of said series of telephone numbers.

61. A method according to claim 60 wherein said assigning is performed by an allocation call addressed to said displayed telephone number

62. A method according to claim 60 wherein said assigning comprises receiving from said allocation call a code identifying said first property.

63. A method according to claim 60 wherein said assigning comprises receiving from said allocation call a voice message identifying said first property.

64. A method according to claim 60 further comprising deriving an allocation number from said assignment call and verifying said allocation number against a list of known allocation numbers.

65. A method according to claim 60 further comprising sending to said allocation number an image of said first property identified.

66. A method of labelling object items with telephone numbers to which telephone numbers object inquiries can be addressed, the method comprising the steps of:
providing a series of unallocated telephone numbers
printing a plurality of labels with said unallocated telephone numbers
displaying on a first object item a first one of said labels; and
subsequently allocating the number on said first label to said first object item, such that each object item is assigned a different one of said series of telephone numbers.

67. A method for providing contact information in response to a request, the method comprising the steps of:
storing in a contact information database contact information corresponding to a first user, and a first user telephone number;
receiving from a second user, a request addressed to the first user telephone number;
deriving from said request, a destination number for said second user;
retrieving from the contact information database contact information assigned to said first user telephone number; and
automatically making available said retrieved contact information to said second user using the derived destination number.

68. A method according to claim 67, wherein said request is a voice call to said first user number.

69. A method according to claim 67, wherein said contact information can be made available without further action by the second user.

70. A method according to claim 67, wherein said retrieved contact information is sent to said second user destination number.

71. A method according to claim 67, wherein said retrieved contact information is sent to said second user in a format to permit direct electronic input into a memory device.

72. A method according to claim 70, wherein said retrieved contact information is sent to said second user as an SMS message.

73. A method according to claim 70, wherein said retrieved contact information is sent to said second user as one of: an electronic business card, a Vcard, flash message, or MMI/MMS.

74. A method according to claim 67, wherein said retrieved contact information includes picture data.

75. A method according to claim 74, wherein said picture information is sent to said second user as a picture message.

76. A method according to claim 67, wherein said contact information is made available in an assigned default format.

77. A method according to claim 70, wherein said second user can select from a list of available formats the format in which the contact information is sent.

78. A method according to claim 67, wherein said retrieved contact information is provided by voice announcement.

79. A method according to claim 67, wherein said retrieved contact information is provided by SMS message if the caller line identification (CLI) number of the request is SMS capable, and wherein said retrieved contact information is optionally announced by voice to said second user otherwise.

80. A method according to claim 67, wherein said destination number for said second user is derived automatically from the request received from said second user.

81. A method according to claim 80, wherein said destination number for said second user is the caller line identification (CLI) number of the request of the second user.

82. A method according to claim 80, wherein said contact information database includes the caller line identification (CLI) number of the request of the second user, and wherein said second user destination number is retrieved from said database, said retrieved number corresponding to the CLI number.

83. A method according to claim 67, further including playing a prompt for the second user destination number, wherein said destination number for said second user is input by the second user in response to the prompt.

84. A method according to claim 67, wherein said destination number for said second user is the CLI number of the request if said number is message enabled, and a voice prompt is played to said second user requesting a destination number otherwise.

85. A method according to claim 67, wherein said contact information database includes a telephone number for said first user, the method further comprising, at the time of making a request, connecting said second user to said first user's telephone number.

86. A method according to claim 85, wherein said contact information database includes more than one telephone number for said first user, and wherein said second user can be connected to an alternative telephone number if said first user's first telephone number is not answered within a certain time period.

87. A method according to claim 67, wherein said contact information database comprises a plurality of categories of contact information.

88. A method according to claim 67, further comprising allowing said first user to enter or update the contact information assigned to said first user number in the contact information database.

89. A method according to claim 67, wherein the first user can select from a supported format a default format in which to send requested contact information.

90. A method according to claim 67, wherein the destination number for said second user is stored in a request database.

91. A method according to claim 90, further comprising automatically providing said first user with details of destination numbers stored in said request database.

92. A method according to claim 91, wherein the destination numbers for requests received in one day is provided to said first user.

93. A method according to claim 90, wherein said details of said destination numbers is automatically sent to said first user by email.

94. A system for providing contact information in response to a request comprising:
an input interface adapted to receive a request from a second user addressed to a first user number;
a processor adapted to derive from said request a destination number for said second user;
a database for storing contact information corresponding to user numbers; and
an output interface adapted to automatically send contact information corresponding to said first user number to said second user destination number.

95. A method according to claim 94, wherein said input interface is a voice based interface.

96. A method according to claim 95, wherein said input interface comprises an IVR interface.

97. A method according to claim 94, wherein said output interface is an SMS communicator.

98. A method according to claim 94, further comprising a user interface to allow said first user to input or update contact information corresponding to said first user number.

99. A method according to claim 98, wherein the user interface allows said first user to select a default format in which said contact information is sent.

100. A method according to claim 98 wherein said user interface allows a first user to select a telephone number to which a second user, on making a request, can be connected.

101. A method according to claim 98 wherein the user interface allows a third user to grant permissions to a first user for inputting or updating contact information corresponding to said first user number.

102. A method according to claim 98 wherein said user interface is web-based.

103. A method of creating a subscriber contact information database for automatically distributing contact information in response to requests, said method comprising:
allowing a subscriber to input or update contact information in said database; and
providing the subscriber with one or more subscription numbers to which requests for contact information can be addressed.

104. A method according to claim 103 wherein the contact information associated with a subscription number is automatically sent to a user in response to a request from said user addressed to that subscription number.

105. A method according to claim 103 wherein a subscriber can enter contact information manually.

106. A method according to claim 103 wherein a subscriber can download information to said database.

107. A method according to claim 103 wherein a subscriber can select a default format in which said contact information is distributed.

108. A method according to claim 103 wherein a subscriber is provided with a plurality of subscription numbers, and wherein the subscriber can grant permissions for the inputting or updating of contact information for selected subscription numbers to selected sub-subscribers.

109. A method according to claim 108 wherein a subscriber can download contact information for some or all of said plurality of subscription numbers.

110. A method according to claim 103 wherein subscribers can preview contact information as it will be distributed.

111. A method for monitoring use of a subscriber contact information system, said system including a subscriber database for storing a subscriber number and associated contact information for subscribers, and said system allowing users to make remote requests for said contact information from said database, the method comprising:
receiving from a user, a request addressed to a subscriber number;
deriving from said request a user destination number; and
creating in a usage database a record of said request including said requested subscriber number and the corresponding user destination number.

112. A method according to claim 111, wherein contact information assigned to said subscriber number is retrieved from the subscriber database and automatically sent to said derived user destination number.

113. A method according to claim 111, wherein said retrieved contact information is sent by SMS message.

114. A method according to claim 111, wherein requests for contact information comprise voice calls.

115. A method according to claim 111, wherein requests for contact information comprise SMS messages.

116. A method according to claim 111, wherein said derived user destination number is the number from which the request was received.

117. A method according to claim 111, further comprising providing to a subscriber a record of requests made to a particular subscriber number and optionally the user destination number corresponding to those requests.

118. A method according to claim 117, wherein the record of requests includes all requests received in a specified time period.

119. A method according to claim 117, wherein the record of requests is sent to said subscriber automatically at the end of a specified time period.

120. A method according to claim 117, wherein said record of requests is sent to said subscriber by email.

121. A method according to claim 111, further comprising providing to a user a record of requests which have been made from, or which relate to a particular user destination number, and the corresponding subscriber number to which those requests were made.

122. A method according to claim 121, wherein said record of requests includes contact information which was returned in response to those requests.

123. A method according to claim 121, wherein the record of requests includes contact information currently associated with those subscriber numbers in said subscriber database.

124. A method according to claim 121, wherein the record of requests is sent to said user by email.

125. A method according to claim 121, wherein the record of requests is sent to said user by SMS message.

126. A method according to claim 111, wherein subscribers are classified into groups, and wherein records from said usage database concerning a group of subscribers is provided to one or more members of said group.

127. A method according to claim 126, wherein a record of requests made to each subscriber number of a group of subscribers is provided to one or more members of said group.

128. A method of forwarding a message from a second user to a first user, the method comprising the steps of:
receiving from a second user, a voice call to a first user number;
recording a voice message from said second user;
retrieving from a user database an email address assigned to said first user number; and
automatically sending said recorded message to said first user via email.

129. A method according to claim 128, wherein said message is sent to said first user as a digitally coded audio file.

130. A method according to claim 128, wherein said message is processed using speech to text processing, and sent to said first user as text.
